(19) United States
(12) Patent Application Publication
(10) Pub. No.: US 2013/0170781 A1
(43) Pub. Date: Jul. 4, 2013

(54) Y-BRANCH DUAL OPTICAL PHASE MODULATOR

(71) Applicants: Karl KISSA, West Simsbury, CT (US); Jason Jiazhan XU, Weatogue, CT (US)

(72) Inventors: Karl KISSA, West Simsbury, CT (US); Jason Jiazhan XU, Weatogue, CT (US)

(21) Appl. No.: 13/338,929

(22) Filed: Dec. 28, 2011

(51) Int. Cl. G02F 1/035

(52) U.S. Cl. 385/3

(57) ABSTRACT

The invention relates to Y-branch waveguide dual optical phase modulators with improved electro-optic (EO) frequency and step responses at frequencies below 1 Hz for use in low-frequency applications such fiber-optic gyroscopes. A Y-branch waveguide structure is formed in an EO substrate, with three or more electrodes used to form a waveguide phase modulator in each of two output waveguide arms. In one embodiment an insulating buffer layer is provided between at least a portion of the electrodes and the substrate for flattening the low-frequency EO response by reducing the modulation efficiency below 1 Hz. In one embodiment each of the waveguide phase modulators includes two ground electrodes extending along both sides of a signal electrode. A top portion of the substrate may be doped to reduce lateral variations of the substrate conductivity in the waveguide and non-waveguide portions thereof between corresponding signal and ground electrodes.

### TECHNICAL FIELD

The present invention generally relates to electrooptic waveguide modulators, and more particularly relates to electrooptic two-output Y-branch waveguide modulators with a flattened time-domain step response and a flattened low-frequency response.

### BACKGROUND OF THE INVENTION

Optical modulators that are based on electro-optical materials incorporating voltage-controlled waveguides are well known in the art and are used in a variety of applications. For high bandwidth application, for example at modulation rates in the 5 GHz to 40 GHz range, such modulators typically include waveguides forming a Mach-Zehnder interferometer structure to achieve optical intensity modulation at the optical output of the device; such modulators are conventionally referred to as Mach-Zehnder (MZ) modulators. High-speed MZ modulators utilize travelling-wave radio-frequency (RF) electrode systems and are described, for example, in an article by E. L. Wooten et al, entitled “A Review of Lithium Niobate Modulators for Fiber-Optic Communications Systems”, IEEE J. OF SELECTED TOPICS IN QUANTUM ELECTRONICS, VOL. 6, NO. 1, JANUARY/FEBRUARY 2000, p. 69-82, which is incorporated herein by reference.

There are however applications that require optical phase modulators which characteristics are optimized for low-frequency applications. FIG. 1 illustrates a prior-art Y-branch dual phase modulator (YBDPM) 10 for use in fiber-optic gyroscopes, as described for example in K. Kissa and J. E. Lewis, “Fiber-optic gyroscopes,” Chapter 23 from “Broadband Optical Modulators,” edited by Antao Chen and Ed Murphy, CRC Press, Boca Raton Fla., 2012, pp. 505-515, and in US Patent Application 2009/0219545 to Feth, both of which are incorporated herein by reference. A fiber optic gyroscope (FOG), which is schematically illustrated in FIG. 2, uses the interference of light to measure angular velocity. Rotation is sensed in a FOG using a large coil of optical fiber forming a Sagnac interferometer. To measure rotation, two light beams are introduced into the coil in opposite directions by an electro-optic modulating device such as the YBDPM of FIG. 1. When the coil rotates, the beam traveling in the direction of rotation experiences a longer path to the other end of the fiber than the beam traveling against the rotation. This is known as the Sagnac effect. As the beams exit the fiber they are combined in the YBDPM 10, and the phase shift between the counter-rotating beams due to the Sagnac effect and modulation in two arms 22, 23 of the YBDPM 10 causes the beams to interfere, resulting in a combined beam, the intensity and phase of which depends on the angular velocity of the coil, and can be detected by a photodetector as shown in FIG. 2.

As opposed to the MZ modulator that has two optical splitter/combiners sandwiching two parallel modulation sections, the YBDPM 10 includes a single waveguide beam splitter/combiner in the form of a waveguide Y-branch 12; this single Y-branch couples a first input/output (IO) waveguide section 21 to two waveguide phase modulation (WPM) sections 13, 14, each supplied with modulating electrodes 15, and each independently connected to respective second and third 10 waveguide sections 22, 23. The electrode topology of the devices shown in FIG. 1 is conventionally found in x-cut lithium niobate (LN) modulators, with co-planar ground and signal electrodes disposed at the sides of each of the waveguide arms. The electrode topology for a modulator based on z-cut LN is similar, except the signal electrodes are positioned on top of the waveguides instead of next to them. In addition, for z-cut LN, a buffer layer may be positioned between the electrode and waveguide to prevent the metal electrode from introducing optical loss. The buffer layer in the prior art devices is typically doped with a metal in order to increase its conductivity at sub Hz frequencies, preventing voltage runaway for bias voltages applied over a long period of time.

The IO waveguide sections 21, 22 and 23 and the Y-junction 12 are conventionally fabricated using Annealed Proton Exchange (APE) waveguides, which guide only one polarization state and thus serve as optical polarizers; hence the YBDMP chip shown in FIG. 1 has a high polarization extinction ratio, which is the power ratio of light in the desired polarization state to the light in the undesired polarization state, as observed at the optical output. It was found, however, that electro-optic (EO) characteristic of APE waveguides may be unstable when exposed to vacuum. Therefore, in the YBDPM 10 illustrated in FIG. 1 the WPM sections 13, 14 utilize Ti waveguides, which are shown as dotted lines in the figure, and which are fabricated by a process of selective titanium diffusion into the LN substrate 11. In the design of FIG. 1, Ti waveguides are stitched in between APE waveguide sections that are shown as thick solid lines, in the region where the electrodes apply an electric field to the waveguide. According to Feth, the electro-optic response of the Ti waveguides is less affected by the presence of a vacuum than the electro-optic response of APE waveguides. The sections of APE waveguide before and after the Ti waveguide section help to reduce any degradation of chip polarization extinction ratio due to the Ti waveguides, which guide all polarization states.

When the YBDPM 10 is used in a FOG, each of the modulation sections is modulated with a periodic or aperiodic waveform in a frequency range that may extend from as low as 10⁻⁶ Hz to about 1 MHz. Typical waveform patterns include sawtooth waves such as serrodyne waveform, square waves, or triangular waves with a period ranging typically from 1 microsecond (μm) to 10⁶ seconds. For a good performance of the FOG, it is required the optical phase of light at the output of the respective WPM section 13 has a one-to-one correspondence with the voltage that is applied to the electrodes 15 to induce an electrical field in the waveguide. However, although the use of Ti waveguides in the modulation portion of YBDPM 10 as described by Feth does appear to improve the device performance, we found that the electro-optic (EO) response of YBDPM 10 still suffers from non-idealities resulting in a non-flat step response, when the optical phase shift in the waveguide continues to change for minutes after a step-wise change in an applied voltage to an new dc level, and a non-flat frequency response of electro-optic characteristics at frequencies below 1 Hz.

An object of the present invention is to provide an improved YBDPM device having a flattened time-domain step response and a flattened low-frequency response.

### SUMMARY OF THE INVENTION

Accordingly, the present invention relates to a Y-branch dual optical phase modulator (DOPM) for use in low-frequency applications that has a flattened EO step response and a flattened EO frequency response at frequencies below 1 Hz.

One aspect of the present invention provides a Y-branch DOPM comprising: a substrate comprising electro-optical material, first, second and third optical ports for coupling light in and out of the substrate, and a Y-branch waveguide structure (YBWS) supported by the substrate for optically coupling the first optical port to each of the second and third optical ports. The YBWS comprises: a first waveguide arm optically connected to the first optical port for receiving light therefrom, a second waveguide arm terminating at the second optical port and comprising a first waveguide phase modulator (WPM) comprising a first modulating waveguide formed in the substrate, a third waveguide arm terminating at the third optical port and comprising a second WPM comprising a second modulating waveguide formed in the substrate, and an optical splitter formed in the substrate and optically connecting the first waveguide arm to each of the second and third waveguide arms for directing the light from the first input port to each of the second and third optical ports. The first and second WPMs further include an electrode system comprising a first signal electrode disposed upon the substrate alongside the first modulating waveguide in the first WPM, a second signal electrode disposed upon the substrate alongside the second modulating waveguide in the second WPM, and at least one ground electrode disposed upon the substrate so as to define first and second electrode gaps extending over and along the first and second modulating waveguide segments, respectively, for supporting a lateral electrical field in any one of the first and second modulating waveguides when a voltage is applied to a respective one of the first or second signal electrodes. The first and second WPMs further include a buffer layer disposed upon the substrate underneath at least a first portion of the electrode system for reducing a low-frequency modulation efficiency of at least one of the first and second waveguide phase modulators for flattening a frequency response thereof at modulation frequencies below 1 Hz.

One aspect of the present invention provides a Y-branch DOPM having a flattened EO step and frequency response, comprising: a substrate comprising electro-optical material; first, second and third optical ports supported by the substrate for coupling light in and out of the substrate, and a YBWS formed in the substrate for optically connecting the first optical port with each of the second and third optical ports. The YBWS comprises a first waveguide coupled to the first port, a second waveguide coupled to the second port and having a modulating waveguide segment, a third waveguide coupled to the third port and having a modulating waveguide segment, and an optical splitter optically connecting the first waveguide to each of the first and second waveguides. A co-planar electrode system is further provided comprising two signal electrodes and at least three ground electrodes disposed upon the substrate so that each of the signal electrodes is adjacent to two of the at least three ground electrodes extending along each side thereof, wherein each of the modulating waveguide segments is located in an electrode gap separating one of the signal electrodes and one of the at least three ground electrodes for inducing an electric field in the first and second modulating waveguide segments when a voltage is applied to the signal electrodes.

One aspect of the present invention provides a Y-branch DOPM having a flattened EO step and frequency response, comprising: a substrate comprising electro-optical material; first, second and third optical ports formed at the substrate for coupling light in and out of the substrate; and, a Y-branch waveguide structure (YBWS) formed in the substrate for optically connecting the first optical port with each of the second and third optical ports. The YBWS comprises: a first waveguide coupled to the first port, a second waveguide coupled to the second port and having a modulating waveguide segment, a third waveguide coupled to the third port and having a modulating waveguide segment, and an optical splitter optically connecting the first waveguide to each of the first and second waveguides. Two signal electrodes and at least one ground electrode are disposed upon the substrate alongside the modulating waveguide segments of the second and third waveguides so that each of the modulating waveguide segments is located in an electrode gap separating one of the signal electrodes and the at least one ground electrode for inducing an electric field in the first and second modulating waveguide segments when a voltage is applied between the signal and ground electrodes. A top portion of the substrate directly under the electrode system is doped so as to reduce lateral non-uniformity of an electrical resistivity of the substrate across the electrode gaps for flattening the EO frequency response of the DOPM at modulation frequencies below 1 Hz.

One aspect of the present invention provides a Y-branch DOPM, comprising: a substrate comprising electro-optical material; first, second and third optical ports formed in or upon the substrate for coupling light in and out of the substrate; and a Y-branch waveguide structure (YBWS) formed in the substrate for optically connecting the first optical port with each of the second and third optical ports, the YBWS comprising: a first waveguide arm coupled to the first port, a second waveguide arm coupled to the second port and having a modulating waveguide segment, a third waveguide coupled to the third port and having a modulating waveguide segment, and an optical splitter optically connecting the first waveguide arm to each of the first and second waveguide arms. A co-planar electrode system is provided comprising two signal electrodes and at least one ground electrode disposed upon the substrate alongside the modulating waveguide segments of the second and third waveguide arms so that each of the modulating waveguide segments is located in an electrode gap separating one of the signal electrodes and the at least one ground electrode for inducing an electric field in the first and second modulating waveguide segments when a voltage is applied between the signal and ground electrodes. Each of the modulating waveguide segments gradually widens by at least 20% towards a middle portion thereof over a length of at least 50 μm for reducing a lateral non-uniformity of electrical resistivity of the substrate across the electrode gaps.

One aspect of the present invention provides a Y-branch DOPM, comprising: a substrate comprising electro-optical material; first, second and third optical ports formed at the substrate for coupling light in and out of the substrate; and a Y-branch waveguide structure (YBWS) formed in the substrate for optically connecting the first optical port with each of the second and third optical ports, the YBWS comprising: a first waveguide arm coupled to the first port, a second waveguide arm coupled to the second port and comprising a modulating waveguide segment, a third waveguide arm coupled to the third port and comprising a modulating waveguide segment, and an optical splitter optically connecting the first waveguide arm to each of the third and second waveguide arms. An electrode system is further provided comprising two signal electrodes and at least one ground electrode that are all disposed upon a same face of the substrate alongside the modulating waveguide segments of the second and third waveguides and forming first and second electrode gaps separating the signal electrodes from the at least one ground electrode, so that the first modulating waveguide segment is located in the first electrode gap and the second modulating waveguide segment is located in the second electrode gap for inducing an electric field in the respective first and second modulating waveguide segments when a voltage is applied between the respective signal and ground electrodes, the electrode system defining first and second phase modulation sections comprising the first and second modulating waveguide segments, respectively. In this aspect of the invention the substrate comprises a top buffer portion upon which at least a portion of the electrode system is disposed, the top buffer portion having a bulk electrical resistivity that is greater than a bulk electrical resistivity of the rest of the substrate for reducing low-frequency contributions of at least one of the waveguide modulating segments in an electrical resistance between each of the signal electrodes and the at least one ground electrodes for flattening a frequency response of the respective waveguide phase modulation section at modulation frequencies below 1 Hz.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a top view of a prior art Y-branch dual phase modulator (YBDPM);

FIG. 2 is a schematic diagram of a prior art fiber-optical gyroscope incorporating the YBDPM of FIG. 1;

FIG. 3 is a graph showing a step in a voltage applied to the YBDPM of FIG. 1;

FIG. 4 is a graph showing an electro-optic response of an ideal YBDPM to the voltage step of FIG. 3;

FIG. 5 is a graph showing an exemplary electro-optic response of the prior art YBDPM of FIG. 1 to the voltage step of FIG. 3 according to measurements;

FIG. 6 is a graph illustrating an exemplary electro-optic frequency response, represented as Vpi(f), of the prior art YBDPM of FIG. 1 to the voltage step of FIG. 3 according to measurements;

FIG. 7 is a partial cross-sectional view of the prior art YBDPM of FIG. 1 showing two electrodes thereof;

FIG. 8 is a schematic top view of a dual optical phase modulator (DOPM) having a buffer layer between the electrodes and the substrate in accordance to one embodiment of the present invention;

FIG. 9 is a partial cross-sectional view of the DOPM of FIG. 8 showing the buffer layer between two electrodes and the substrate, with the cross-section taken along line ‘AA’ in FIG. 8;

FIG. 10 is a cross-sectional view of a three-electrode embodiment of the DOPM of FIG. 8 showing the buffer layer between three electrodes and the substrate;

FIG. 11A is the cross-sectional view of the three-electrode embodiment of the DOPM with an equivalent electrical scheme thereof superimposed;

FIG. 11B is the partial cross-sectional view of the DOPM of FIG. 9 showing an equivalent electrical scheme of one of the phase modulating sections thereof;

FIG. 12 is a cross-sectional view of a three-electrode embodiment of the DOPM of FIG. 8 with the buffer layer extending only partially under the ground electrodes;

FIG. 13 is a cross-sectional view of a three-electrode embodiment of the DOPM of FIG. 8 with the buffer layer extending only partially under the ground and signal electrodes;

FIG. 14 is a cross-sectional view of a three-electrode embodiment of the DOPM of FIG. 8 with the buffer layer extending only partially under the ground electrodes and absent under the signal electrode;

FIG. 15 is a cross-sectional view of a three-electrode embodiment of the DOPM of FIG. 8 with the buffer layer existing only under a central portion of the signal electrode;

FIG. 16 is a partial cross-sectional view of an embodiment of the DOPM of FIG. 8, with the cross-section taken along line ‘AA’ shown in FIG. 8, wherein the buffer layer extends only partially under the ground and signal electrodes;

FIG. 17 is a partial cross-sectional view of an embodiment of the DOPM of FIG. 8, with the cross-section taken along line ‘AA’ shown in FIG. 8, wherein the buffer layer exists only under one of the ground and signal electrodes;

FIG. 18 is a partial cross-sectional view of an embodiment of the DOPM of FIG. 8, with the cross-section taken along line ‘AA’ shown in FIG. 8, wherein the buffer layer exists only under a portion of only one of the ground and signal electrodes;

FIG. 19 is a top view of an embodiment of the DOPM of FIG. 8 wherein the buffer layer extends longitudinally only under a portion of the electrode system thereof, and is absent along a portion of the length of each of the electrodes;

FIG. 20 is a partial cross-sectional view of an embodiment of the DOPM of FIG. 8, with the cross-section taken along line ‘AA’ in FIG. 8, wherein the buffer layer is in the form of a shallow doped top portion of the substrate under the electrodes;

FIG. 21 illustrates an embodiment of the DOPM of FIG. 20 in a same partial cross-sectional view, wherein the doped top portion of the substrate extends to a same or greater depth than the waveguide;

FIG. 22 is a schematic top view of a DOPM with the modulating waveguides that widen in the middle in accordance with one embodiment of the present invention;

FIG. 23 is a partial cross-sectional view of an embodiment of the DOPM of FIG. 22 schematically showing one of the modulating waveguides in two cross-sections taken along lines ‘AA’ and ‘BB’ in FIG. 22;

FIG. 24 is a graph schematically illustrating contributions of the buffer/substrate interface (short-dashed line 201) and substrate/waveguide interface (long-dashed line 202) into the EO frequency response (solid line 203) for one embodiment of the DOPM of FIG. 8;

FIG. 25 is a top view of an embodiment of the DOPM of FIG. 8 with the signal electrodes that are narrower than the ground electrodes;

FIG. 26 is a partial cross-sectional view of the DOPM of FIG. 25 taken along line ‘AA’;

FIG. 27 is a graph schematically illustrating contributions of the reduced buffer/substrate interface (short-dashed line 201′) and substrate/waveguide interface (long-dashed line 202) into an improved EO frequency response solid line 203′) for the DOPM of FIG. 25 with a narrower signal electrode;

FIGS. 28 to 30 are top views of three different embodiments of the DOPM of FIG. 25 having four ground electrodes, with two ground electrodes at the sides of each of the signal electrode in each modulating section;

FIG. 31 is a top view of an embodiment of the DOPM of FIG. 30 wherein two ground electrodes between the modulating waveguides are merged into a single electrode;

FIG. 32 is a top view of an embodiment of the DOPM of FIG. 28 wherein all electrodes and the modulating waveguides extend into bends of the waveguide arms part-way towards a junction thereof;

FIG. 33 is a schematic diagram of a fiber-optical gyroscope incorporating a DOPM according to an embodiment of the present invention;

FIG. 34 is a schematic diagram showing an optical coupler of the DOPM of the present invention in the form a directional waveguide coupler;

FIG. 35 is a schematic diagram showing an optical coupler of the DOPM of the present invention in the form a multi-mode interference coupler;

FIG. 36 is a schematic top view of an embodiment of the DOPM of FIG. 8 with fiber-optic ports.

### DETAILED DESCRIPTION

In the context of this specification, the terms ‘disposed on/upon’, ‘located on/upon’ and their equivalents are used to indicate relative position of two elements and encompass situations wherein two elements are in a direct physical contact or have one or more additional elements between them. The term “disposed directly on/upon” means herein that the two elements are in a direct physical contact. The term ‘low frequency’ with reference to an EO frequency response or modulation efficiency means herein frequencies from about 1 Hz down to 0.00001 Hz or less, unless stated otherwise. The term ‘low-frequency application’ is used herein to mean applications wherein the device is modulated at frequencies generally below about 1 MHz and including frequencies in the range from about 1 Hz down to 0.00001 Hz or less, unless stated otherwise.

Prior to providing a detailed description of exemplary embodiments, we first describe some drawbacks of prior art YBDPM devices, in particular non-idealities in their time-domain and frequency-domain EO responses.

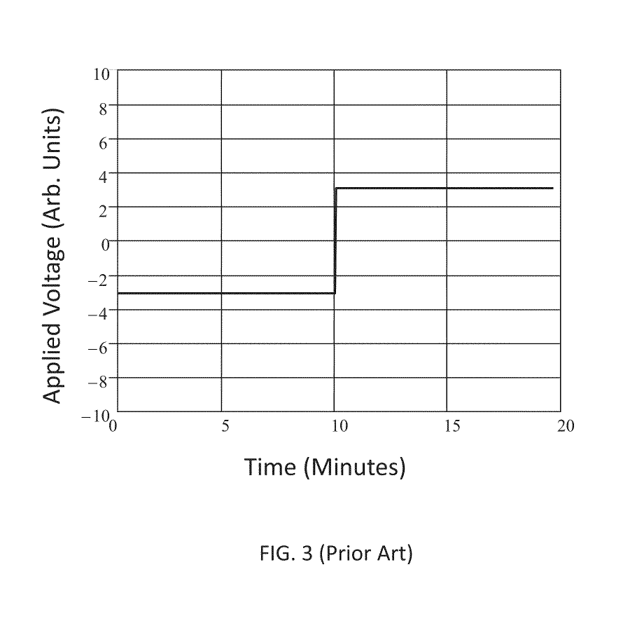

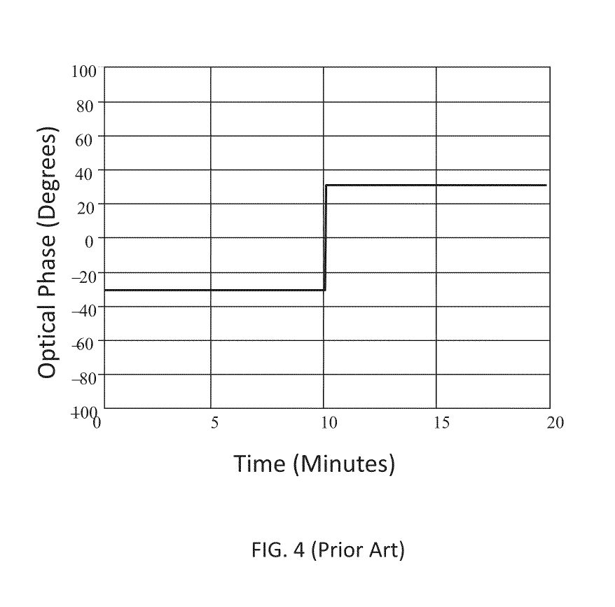

More specifically, a step-wise change in the voltage applied to the electrodes 15 should ideally generate a flat step-wise change in the output optical phase. This is illustrated in FIGS. 3 and 4, wherein FIG. 3 shows a plot of applied voltage vs. time, where the voltage units are arbitrary and the time units are minutes, while FIG. 4 describes the ideal electro-optic (EO) step response, i.e. the time-dependence of the optical phase at the output of a WPM section when the applied voltage is stepped from one DC voltage level to another as in FIG. 3. In the ideal EO step response of FIG. 4, the optical phase at the outputs of the modulator stays substantially constant, i.e. ‘flat’, a second or less after the applied voltage is set to a new value, and remains constant for minutes or more. The term ‘step response’ or ‘EO step response’ is used herein to mean a time-domain response of the optical phase accrued in a phase modulator to a step in the applied dc voltage. FIG. 4 shows an approximate 60 degree abrupt change in differential optical phase. The actual magnitude of the phase change depends on the applied voltage and the Vpi of the modulator. Parameter Vpi, also denoted V_{π}, is defined as the applied voltage required to produce a 180 degree change in the optical phase at the output of an EO modulator. For an ideal EO step response, the step change in the optical phase is flat with time, that is, there is no sign of any relaxation or amplification of the optical phase with time seconds after the abrupt change in the applied voltage.

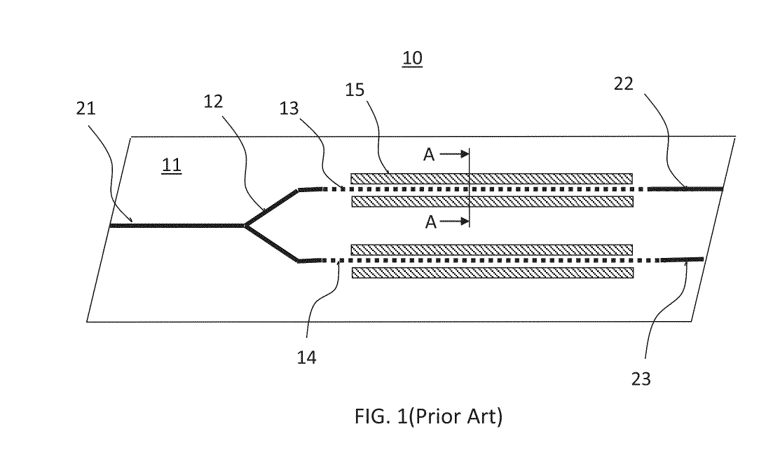

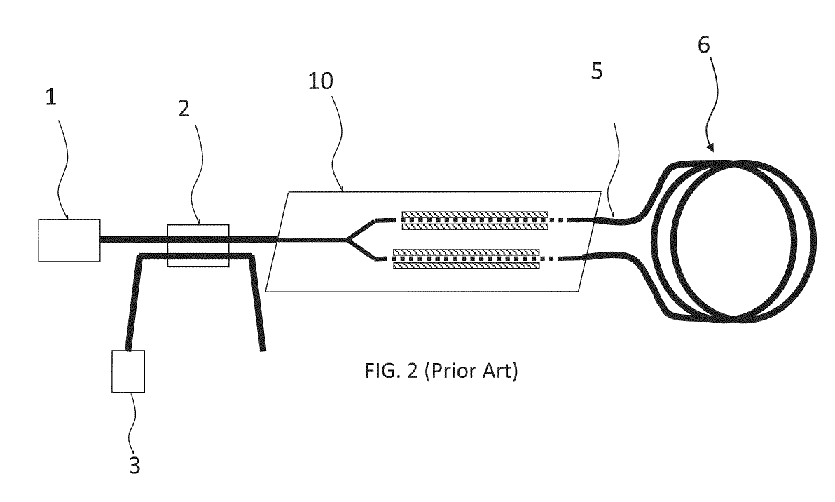

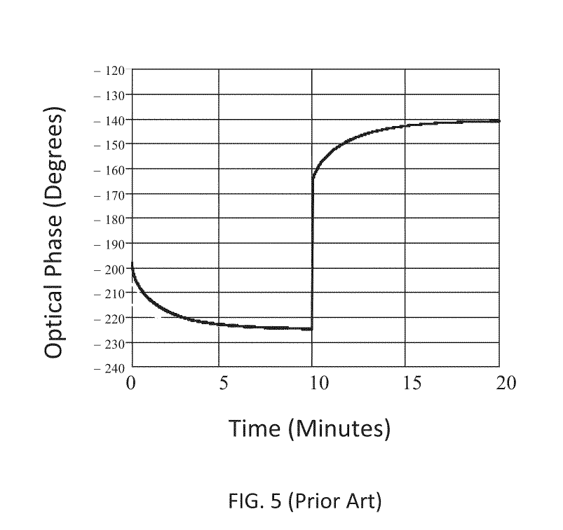

We observed, however, that the real-life behavior of the phase change in the YBDPM 10, even with stitched-in Ti-indiffused waveguides, differs from the ideal response illustrated in FIG. 4. More specifically, FIG. 5 shows the measured optical phase vs. time behavior for the YBDPM 10 of FIG. 1 with Ti waveguides in the electrode region, where the applied voltage with time has the same shape as the plot shown in FIG. 3. The modulator temperature was 70° C. Note that the optical phase change grows with time after the step change in applied voltage, before finally leveling off after about 17 minutes. The time constant for the leveling off appears to be greater than one minute. The continuing change in the optical phase after the new voltage is set is a clear disadvantage for applications that require a fixed optical phase change in the waveguide with time for a fixed voltage.

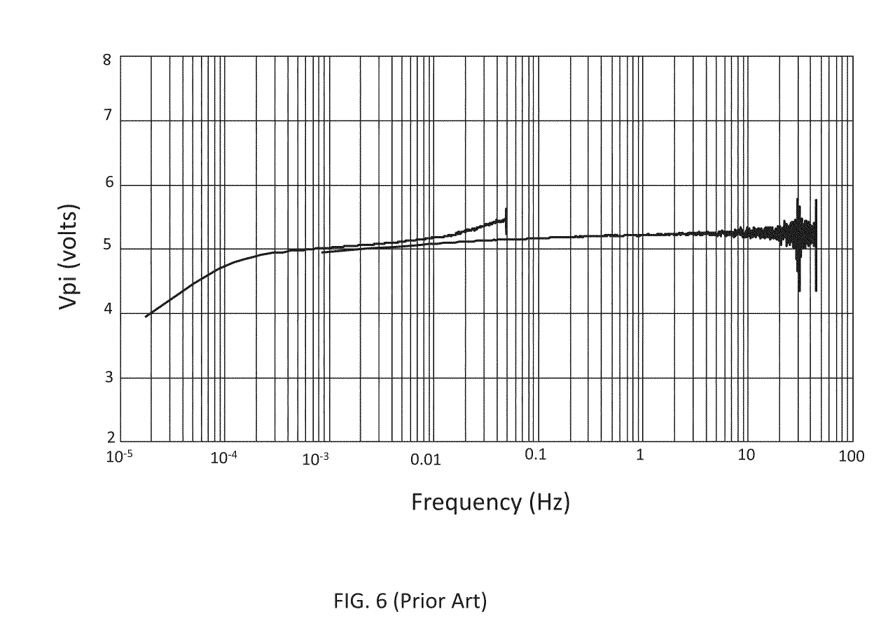

FIG. 6 shows a measured EO frequency response, represented in this particular figure as Vpi vs. modulation frequency, for a phase modulator with Ti waveguide. The EO frequency response may be determined by the ratio of the Fast Fourier Transform (FFT) of the electro-optic step response as shown in FIG. 5 to the FFT of the applied voltage waveform as shown in FIG. 3. The Vpi is proportional to the inverse of this ratio. Multiple steps of different durations can be applied to produce frequency content over a broad frequency range. Step response to voltage steps having short duration are measured with faster sample rates (90 Hz), whereas step response to voltage steps with long duration are sampled at a slow rate (0.1 Hz). Two curves shown in FIG. 6 are generated due to the two sets of sampling rates. There is a discontinuity between the curves in the frequency region of 0.01 Hz to 0.1 Hz, which is an artifact of the data analysis method and is related to the uncertainty in the measured value derived from the 0.1 Hz sample rate. Square shaped voltages with long duration sampled with 0.1 Hz sample rate have only a small amount of frequency content near the sample rate, causing the derived frequency response to be more affected by noise and other uncertainties. Similarly, the response near 10 Hz, which is derived from data taken at the 90 Hz sample rate, becomes affected by noise, causing some oscillation in the derived response near 10 Hz. The oscillations are not real, but an artifact of the measurement and data analysis method.

The ideal flat step response that is illustrated in FIG. 4 would correspond to a flat frequency response with a frequency-independent Vpi, i.e. as would be represented by a horizontal line in FIG. 6. Instead as can be clearly seen from FIG. 6, measured Vpi is frequency-dependent and decreases as modulation frequency f decreases, falling as much as 40% at f˜10⁻⁵ Hz relative to f˜1 Hz, for temperature of 70° C.

The present invention address this drawback of the prior art YDBOMs by providing means to flatten both the frequency domain EO response at sub-Hz frequencies, and the time-domain step response. In one aspect of the present invention, the response is flattened by the addition of a non-conductive buffer layer between at least a portion of the electrode system of the device and the substrate.

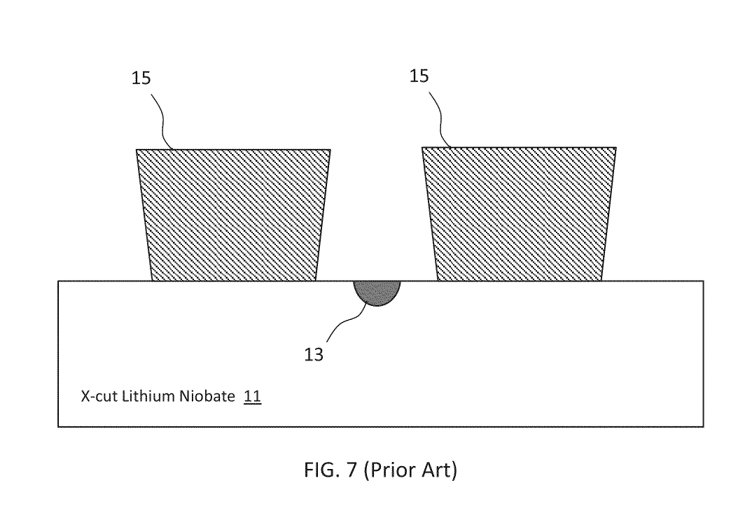

With reference to FIG. 7, there is illustrated a vertical cross-section of the prior art YBDPM 10 along an A-A line across one of the modulated waveguides, namely waveguide 13, and the adjacent thereto electrodes 15, as shown in FIG. 1. As seen from the figure, the electrodes 15 are disposed directly upon the LN substrate 11 in which the waveguide 13 is formed, in the absence of any insulating buffer therebetween. While buffer layers are used in high-speed MZ modulators for the purpose of matching electrical and optical velocities and increasing the HF bandwidth, they are not used in prior art modulators for low-frequency applications such as YBDPM devices, as the non-buffered modulators have been shown to have higher modulation efficiency at frequencies below about 2 GHz. See, for example, an article by Ed Wooten, et. al., “A review of lithium niobate modulators for fiber-optic communication systems,” IEEE Journal of Selected Topics in Quantum Electronics,” Vol. 6, No. 1, January/February 2000, pp. 69-82, which is incorporated herein by reference, and in particular FIG. 5 of this reference, showing more than 8 dB higher low-frequency modulation efficiency for non-buffered x-cut LN MZ modulators than MZ modulators using a buffer. For this reason, prior-art low-frequency YDBPMs use non-buffered electrode systems.

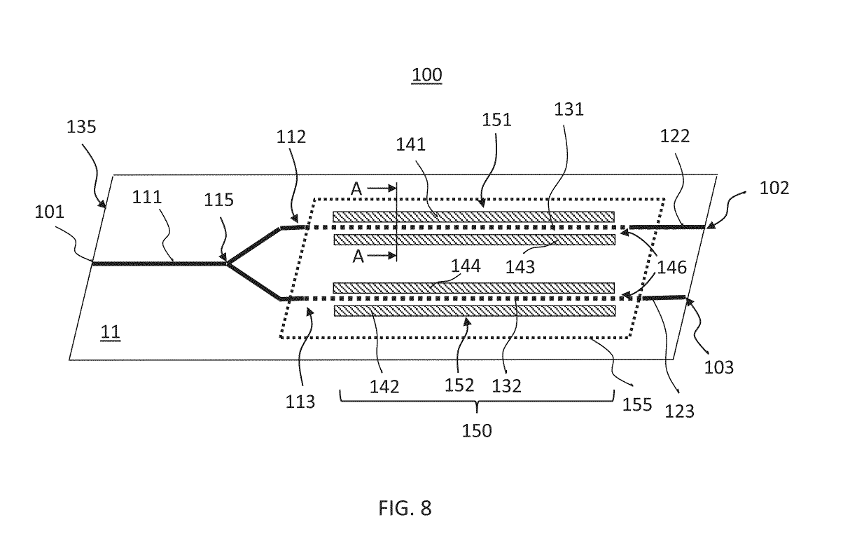

With reference to FIG. 8, one embodiment of the present invention provides a Y-branch dual optical phase modulator (DOPM) 100 for use in low-frequency applications such as FOG. The DOPM 100 is generally similar in topology to the YBDPM 10, but additionally includes a buffer layer 155 disposed upon a substrate 11 beneath electrodes 141-144. More particularly, DOPM 100 is an integrated optical circuit that is formed in a substrate 11 of electrooptic material and has three optical ports, namely a first optical port 101, a second optical port 102, and a third optical port 103. The first optical port 101 is optically connected to the second and third optical ports 102, 103 by means of a first waveguide 111, a second waveguide 112, a third waveguide 113, and an optical splitter-combiner 115, which is in the form of a waveguide Y-junction in the shown embodiment. The first, second and third waveguides 111, 112, 113 are also referred to herein as the first, second and third waveguide arms, respectively, or simply as the waveguide arms. The optical splitter-combiner 115 optically connects the first waveguide 111 to proximate ends of each of the second waveguide 112 and the third waveguide 113, with the distal end portions 122, 123 of the second and third waveguides 112, 113 terminating at the second and third optical ports 102, 103, respectively. The first, second and third waveguides 111-113 and the optical coupler 115 together form a Y-branch waveguide structure (YBWS) that is formed in the substrate 11 for optically connecting the first optical port 101 with each of the second and third optical ports 102, 103. The substrate 11 may be of any suitable electro-optic material; in the description hereinbelow it is assumed to be made of an x-cut LN for the sake of clarity, unless stated otherwise. In other embodiments, the substrate 11 may be fabricated from other electrooptic materials including but not limited to z-cut LN, LiTaO₃, InP, GaAs.

The electrodes 141-144 are provided for modulating light propagating in the waveguide arms 112, 113, and are collectively referred to herein as the electrode system of the DOPM 100. In the shown embodiment the electrode system consists of four co-planar stripe electrodes, with two outer electrodes 141, 142 and two inner waveguides 143, 144, which are disposed over the substrate 11 in direct or in-direct contact therewith in a modulator portion 150 of the device. The electrodes 141-144 extend alongside each of the waveguide arms 112, 113, defining two electrode gaps 146 wherein portions 131, 132 of the waveguide arms 112, 113 are located. In the following, portions 131, 132 of the waveguide arms 112, 113 that are sandwiched between two electrodes are referred to as modulating waveguide segments (MWS), or simply as modulating waveguides 131, 132. In the shown embodiment, the modulating waveguide segments 131, 132 are Ti waveguides and are shown in the figure with thick dotted lines. The modulating waveguide 131 together with the associated electrodes 141, 143 closest thereto are referred to herein as the first phase modulation section 151 or the first waveguide phase modulator (WPM) 151, while the modulating waveguide 132 together with the associated electrodes 142, 144 closest thereto are referred to herein as the second modulation section 152 or the first waveguide phase modulator (WPM) 152. Accordingly, the DOPM 100 includes two WPMs 151, 152 located in the waveguide arms 112, 113 that terminate at the output ports 102, 103, respectively. Note that there is only one optical splitter/combiner in the DOPM 100.

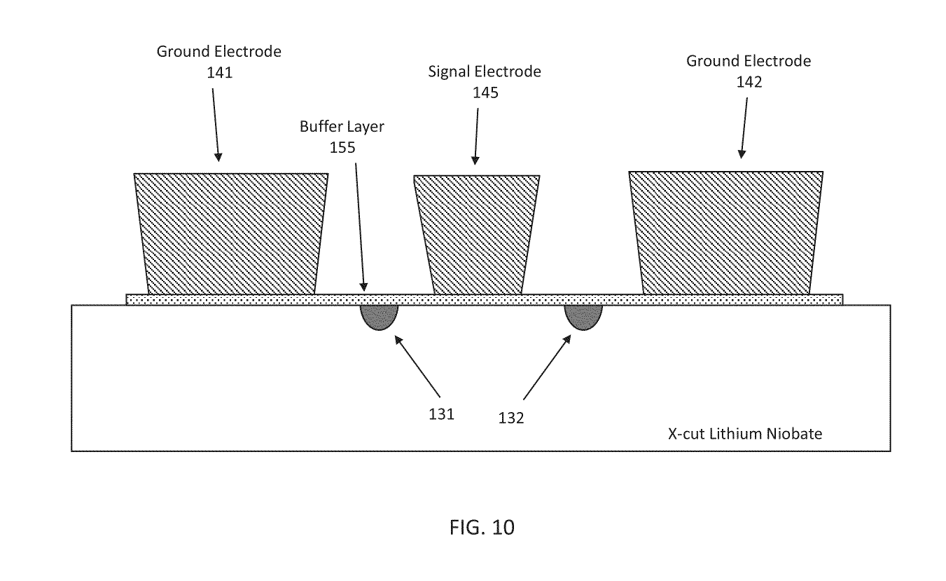

In operation, a voltage applied between electrodes 141 and 143 induces lateral electrical field in the MWS 131, changing its refractive index and effecting a change in the optical phase of light propagating therein. Similarly, a voltage applied between electrodes 142 and 144 effects an optical phase change for light propagating in MWS 132. In the context of the present specification, the lateral direction is a direction in the plane of the substrate 11 across each or one of the modulating waveguides 131, 132 normal to their general direction, while the direction along any of the modulating waveguides 131, 132 is referred to as the longitudinal direction. For the sake of clarity we will be referring to the outer electrodes 141, 142 as signal electrodes or hot electrodes, and to the inner electrodes 143, 144 as ground electrodes; the ‘signal’ and ‘ground’ designations may however be reversed in some embodiments. In operation, ground electrodes are connected to the ground, and the modulating voltage is applied to the signal electrodes. Furthermore, in some embodiments wherein the waveguide arms 112, 113 are to be synchronously modulated with a same electrical signal, they may be disposed close to each other and the inner electrodes 143, 144 joined together to form a single central signal electrode 145 as illustrated in FIG. 10 in cross-sectional view, with the outer electrodes 141 and 142 serving as ground electrodes. In some embodiments, wherein the waveguide arms 112, 113 are sufficiently close, the inner electrodes 143, 144 may be merged into a single electrode, which in this case is shared between the first and second MSs 151, 152. Generally, the electrode system of DOPM 100 may include three or more electrodes.

In accordance with an embodiment of the invention, a buffer layer 155 is disposed upon the substrate 11 underneath the electrode system 141-144 for providing a flattened time-domain step response and a flattened low-frequency response of the DOPM 100 to an applied voltage signal.

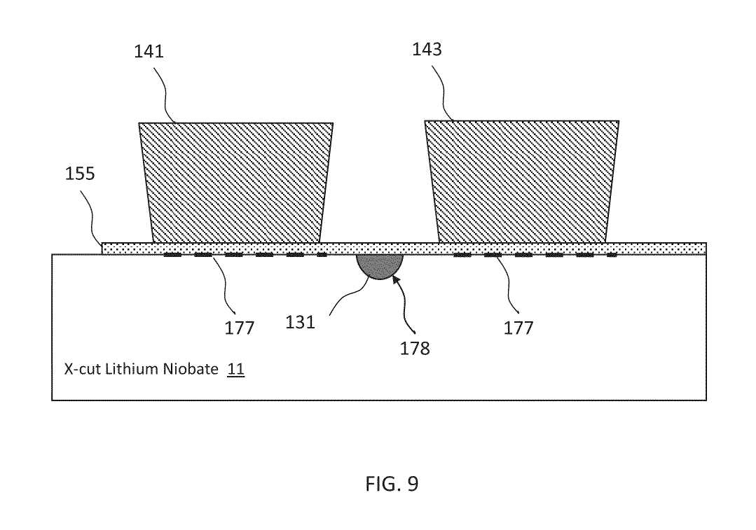

FIG. 9 shows the buffer layer 155 disposed between the electrodes 141 and 143 and the substrate 11 in a cross-sectional view along an ‘AA’ line shown in FIG. 8. FIG. 10 shows the cross-section of an embodiment of DOPM 100 with closely positioned MWSs 131, 132 wherein the two inner electrodes 143, 144 are replaced by a single centrally positioned signal electrode 145, with the buffer layer 155 disposed between the electrodes 141-143 and the substrate 11.

The buffer layer 155 is preferably made of an electrically and environmentally stable material with a bulk electrical resistivity that is at least as high, or preferably higher than the bulk electrical resistivity of the material of the substrate 11. In one embodiment, the bulk electrical resistivity ρ_{b} of the buffer layer is preferably at least twice greater that the bulk electrical resistivity ρₛ of the substrate 11, and more preferably at least 10 times greater than ρₛ. Suitable materials for use in the buffer 155 on LN substrates include but not limited to benzocyclobutene (BCB) and undoped SiO₂. One drawback of BCB is that the conductivity of BCB may change in the presence of humidity. Therefore in embodiments wherein the buffer layer is formed of BCB, it may be covered by an encapsulating ‘bleed’ layer, such as a layer of TaSiN or SiN, to protect the BCB layer from humidity. The choice of conductivity of the encapsulating layer is another variable that may affect sub Hz frequency response.

We found that the addition of this resistive buffer layer 155 facilitates flattening of the law-frequency EO characteristic of the DOPM 100 as compared to the prior art YBDPM devices without the buffer layer, in particular for devices utilizing Ti waveguides in the modulation section. This can be understood as follows.

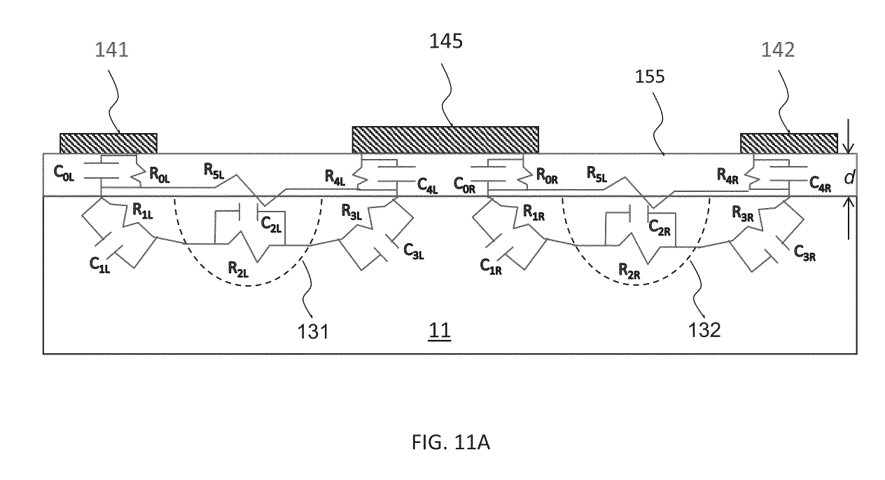

With reference to FIG. 11A, there is schematically represented an equivalent electrical circuit of the DOPM 100 in the embodiment of FIG. 10, which is superimposed on the device's cross-section and shows resistances and capacitances related to various regions of the device cross-section. The drawing is for the case where the modulating waveguides 131, 132 are close to one another, but also applies for the case of FIGS. 8, 9 with the waveguides 131, 132 far apart and two inner electrodes. In that case, an equivalent electrical circuits for one of the WPMs, for example WPM 151, may be obtained from the circuit of FIG. 11A by removing the right-most electrode 142 and the electrical circuit connecting it to the central electrode 145, resulting in an exemplary equivalent circuit for the WPM 151 that is illustrated in FIG. 11B. In FIGS. 11A, 11B, capacitances C_{1L}, C_{1R}, C_{3L}, and C_{3R} and resistances R_{1L}, R_{1R}, R_{3L}, and R_{3R} model the charge accumulation and charge migration, respectively, within portions of the substrate 11 that are outside of the waveguides 131, 132. The capacitances C_{2L} and C_{2R} and resistances R_{2L} and R_{2R}, model the charge accumulation and charge migration, respectively, within each of the waveguides 131, 132. The capacitances C_{0L}, C_{0R}, C_{4L}, and C_{4R} and resistances R_{0L}, R_{0R}, R_{4L}, and R_{4R} model electrical properties of the buffer layer 155. In the absence of the buffer layer, modulation efficiency for the waveguides is determined by a voltage division between the non-waveguide and waveguide portions of the substrate 11.

The waveguide modulation efficiency is determined by a fraction of the applied voltage V that drops across the modulating waveguide 131, where V is the voltage applied between the corresponding signal and ground electrodes of the WPM 151 in this example. This fraction Vw/(Vnw+Vw) in turn depends on the voltage division ratio r_{V}=Vw/Vnw between the voltage drop Vw across the waveguide 131 and the voltage drop Vnw outside the waveguide. At high frequencies in the range of kHz or higher, the capacitive voltage division dominates, and the structure functions as if the resistors were not present. Similarly, at very low frequency, resistive voltage division dominates, and the structure functions as if the capacitors were not present. If the capacitive and resistive voltage division ratios r_{V} are different, the EO frequency response of each WPM will change from high to low frequency. The terms ‘frequency response’ and “EO frequency response” are used herein interchangeably to mean the modulation efficiency of any one of the WPMs 151, 152 for a single-frequency, e.g. sinusoidal, voltage modulation signal applied to the signal electrode of the respective WPM. In particular, for Ti waveguides, it is found that the low frequency sub-Hz response is slightly stronger, i.e. the modulation efficiency is higher, than at high frequency, indicating that the resistive contribution of the non-waveguide portion of the substrate is smaller than the capacitive one in proportion to the resistance or capacitance within the waveguide. APE waveguides have opposite behavior, having less efficient EO frequency response at below 1 Hz relative to high frequency. Hence, for Ti waveguides, conductivity within the waveguide is likely to be lower compared to conductivity outside the waveguide, while APE waveguide structures have a relatively higher conductivity within the waveguide than outside the waveguide.

The introduction of a low conductivity—high resistivity buffer layer 155 adds a high resistance values R_{0L}, R_{0R}, R_{4L}, and R_{4R}, in series with resistors R_{1L}, R_{2L}, R_{3L}, and R_{1R}, R_{2R}, and R_{3R}, thereby reducing the frequency response at low frequency when the resistive contribution dominates over the capacitive one. The low conductivity buffer layer 155 helps to compensate for the rise in frequency response, or equivalently the reduction of Vpi, that occurs due to non-uniform conductivities within the substrate 11 inside and outside the waveguides 131, 132 as illustrated in FIG. 6. By properly choosing the buffer thickness d, the resistor values associated with the buffer layer 155 can be adjusted so as to flatten the sub Hz frequency response of the DOPM 100. By way of example, suitable thickness of a BCB buffer layer may vary between 0.3 μm and 1.0 μm, or preferably between 0.55 μm and 0.75 μm, but may also be outside of these ranges depending on the device design and the actual buffer conductivity; those skilled in the art will be able to determine a suitable buffer thickness by means of computer modeling and/or simple experimentation.

One issue that may arise due to the addition of the buffer layer 100 is that the corner frequency f_{cb}˜(C_{0L}R_{0L})⁻¹ introduced in the frequency response of the DOPM 100 by the buffer layer 155 may not be exactly equal to the corner frequency f_{cs} that is defined by the RC values associated within the substrate 11. Another possible issue is that the change in low frequency response brought about by the addition of the buffer 155 is too large even for a thin buffer layer. Hence, additional degrees of freedom may be needed to enable further tailoring of the frequency response of DOPM 100 at low frequencies.

Accordingly, one aspect of the invention provides Y-branch DOPM devices combining buffered and unbuffered electrodes or electrode portions, wherein the buffer layer is disposed underneath only a portion of the electrode system of the device, which is referred to hereinafter also as the first portion, and wherein a second portion of the device electrode system is disposed directly upon the substrate 11 in the absence of the buffer layer underneath thereof.

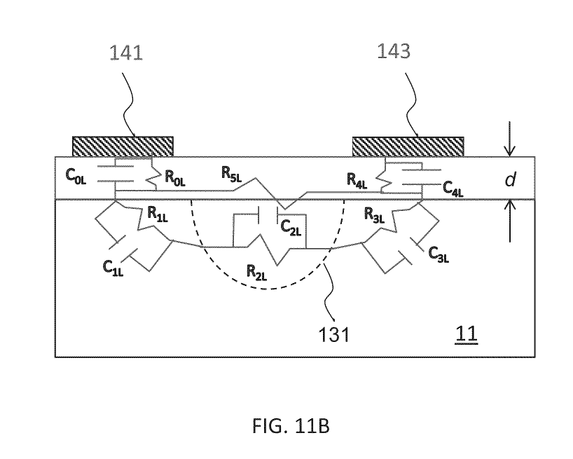

Referring to FIG. 12, there is shown an embodiment of DOPM 100 with the single central electrode 145 in a same cross-sectional view as that of FIG. 10, wherein outer portions of the ground electrodes 141, 142 are in direct contact with the substrate 11 while inner portions thereof, i.e. those closer to the respective waveguides, and the central signal electrode 143 is separated from the substrate 11 by the buffer 155.

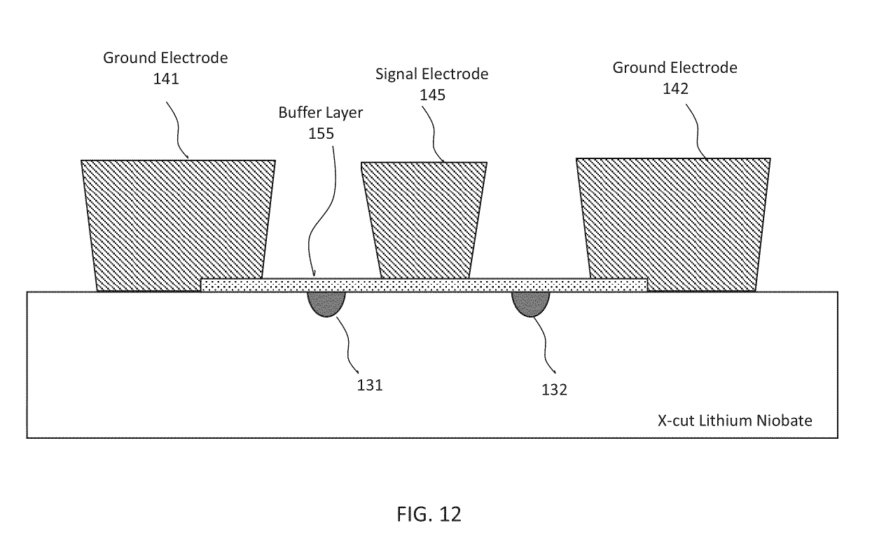

Referring to FIG. 13, there is shown an embodiment of DOPM 100 with the single central electrode 145, wherein each of the electrodes 141, 142, 145 has a first portion that is deposed upon the buffer 155, and a second portion that is in a direct contact with the substrate 11.

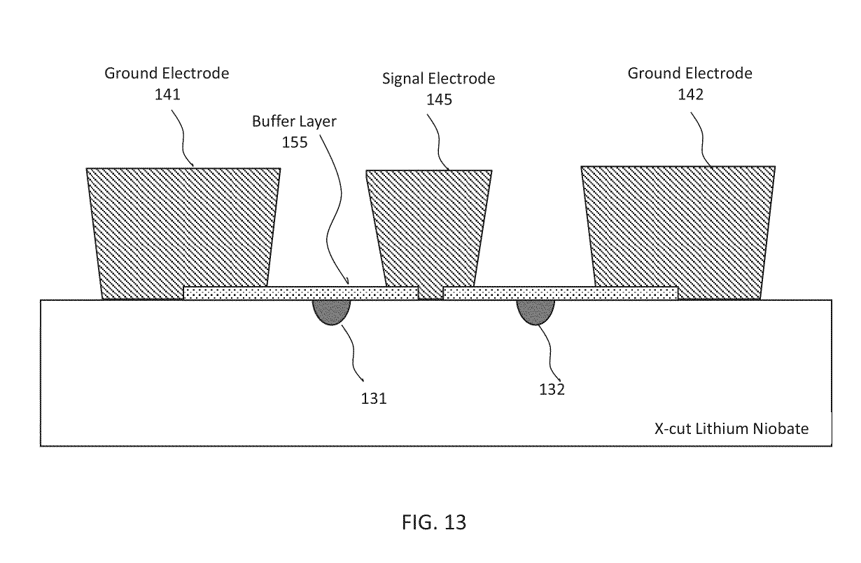

FIG. 14 illustrates an embodiment wherein only a portion of each of the ground electrodes 141, 142 is disposed on the buffer 155, with the central electrode 145 disposed directly upon the substrate 11.

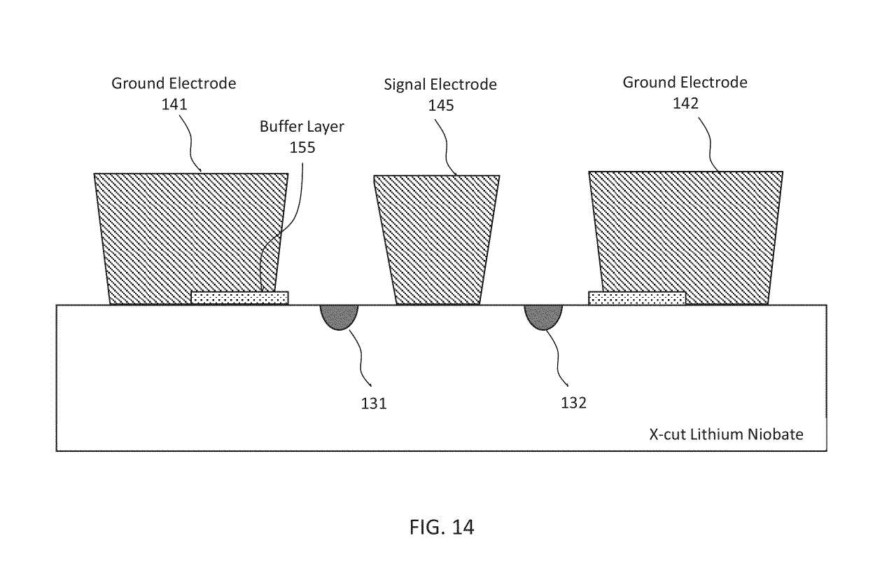

FIG. 15 illustrates an embodiment wherein only a portion of the central electrode 145 is disposed on the buffer 155, with the rest of the electrode system disposed directly upon the substrate 11 without the buffer.

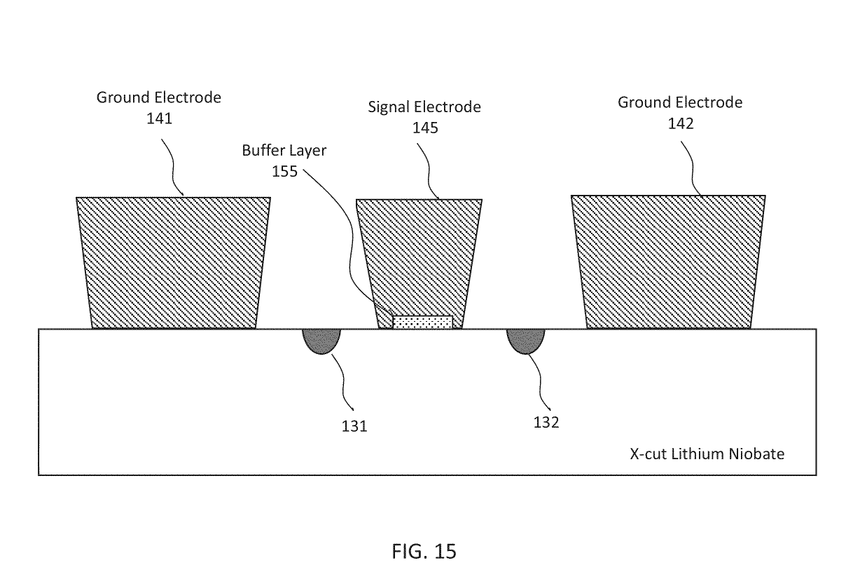

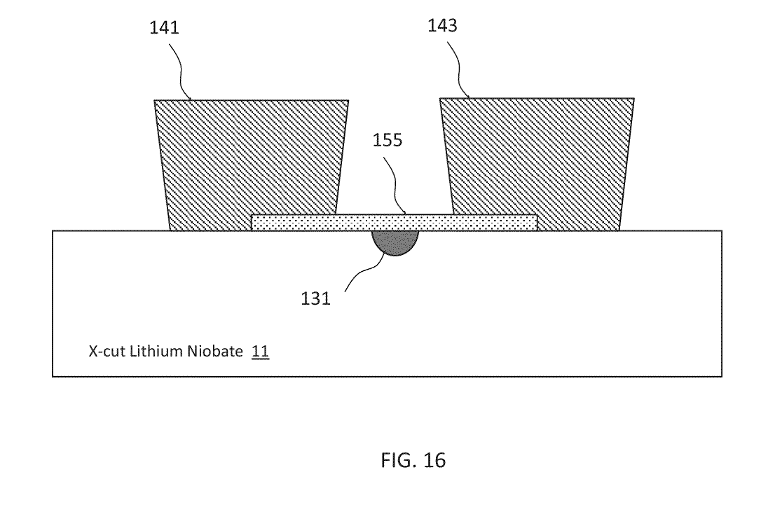

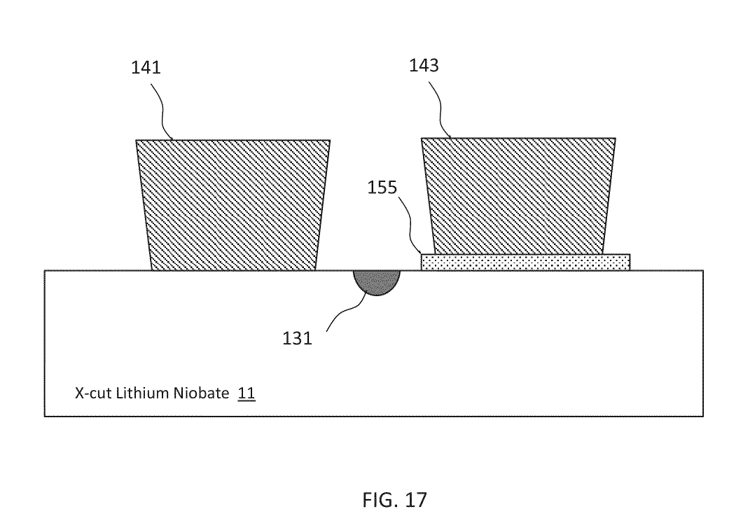

FIGS. 16-18 illustrate four-electrode embodiments of the DOPM 100 in a same cross-sectional view as that of FIG. 9, i.e. showing by way of example only the first modulating section, or WPM, 151 of the device in a cross-section through the upper modulating waveguide 131 and the associated electrodes 141, 143 along the line ‘AA’ in FIG. 8. In each of these embodiments, a portion of at least a signal electrode 141 or a ground electrode 143 is disposed over the buffer 155, while a second portion of the signal or ground electrode is disposed directly upon the substrate without the buffer.

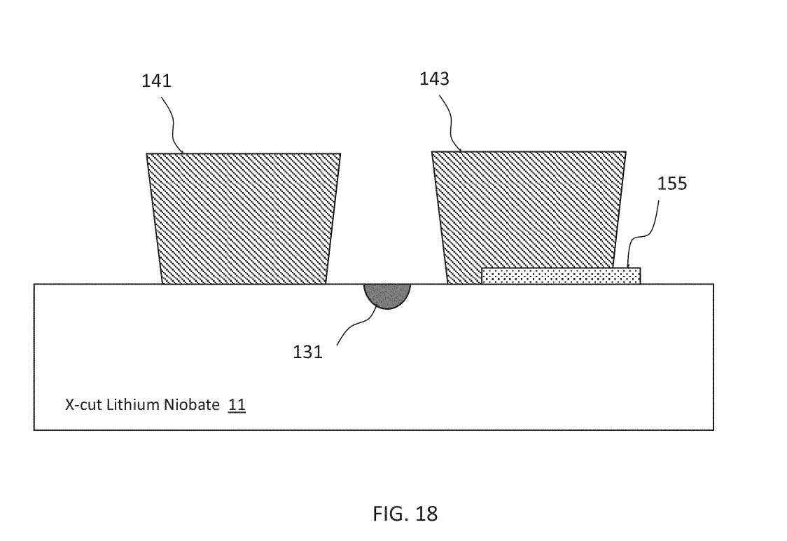

The buffered and non-buffered portions of the electrode system of the DOPM 100 may be combined both laterally across the waveguides 131, 132 as illustrated in FIGS. 12-18 and longitudinally, along the length of the waveguides 131, 132. The latter option is illustrated in FIG. 19, wherein the buffer layer 155 exists under each of the electrodes 141-144 along a first length portion of the device 100 as indicated by an arrow 140-1, while each of the electrodes are in a direct contact with the substrate along a second length portion 140-2 of the DOPM. In the embodiment shown in FIG. 19 the buffer 155 is in a middle portion of the modulating region of the device, however other positions and orientations of the buffer 155 along or across the length of the waveguides 131, 132 are also possible and within the scope of the present invention.

Advantageously, by having the electrode system partially disposed over the buffer 155, and by suitably adjusting the relative size and positioning of the buffer 155 under the electrode system of the DOPM 100, the electrical resistances and capacitances associated with the buffer layer 155 can be suitably adjusted so as to optimally flatten the low-frequency EO response of the device, and therefore to flatten the time-domain step response thereof.

By way of example, we found that the addition of a BCB buffer layer that partially extends under the ground electrodes 141, 142 in the three electrode configuration of the DOPM 100, as illustrated in FIG. 12, resulted in about three-fold reduction in the variation of the EO response versus frequency in the sub-Hz frequency range, and a similar in magnitude flattening of the EO step response on a time scale from a few seconds to several minutes, as compared to similar devices without the buffer layer. The measured devices had Ti waveguides fabricated in an x-cut LN substrate, with 215 μm wide electrodes separated by 14 μm wide electrode gaps. In this particular example, the buffer layer was about 0.65 μm thick and extended under the ground electrodes up to about 30% of their width, so that about 70% of the ground electrodes' area had no buffer layer underneath and was in a direct contact with the LN substrate, as illustrated in FIG. 12.

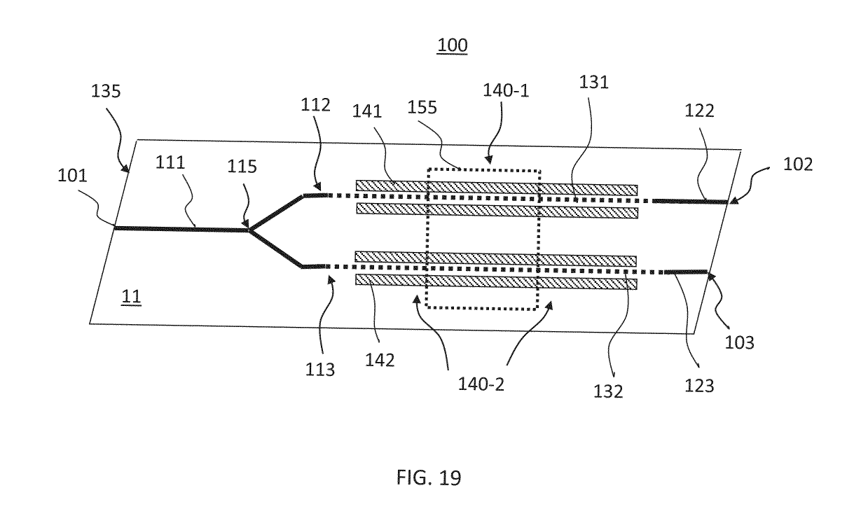

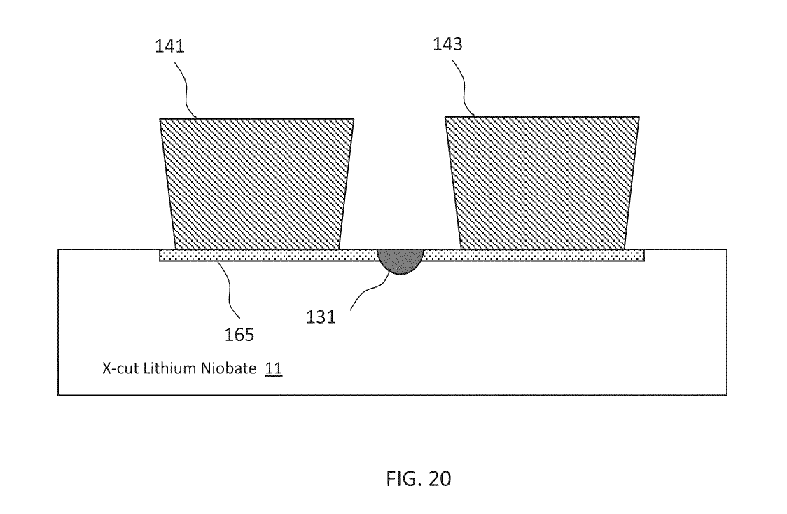

With reference to FIGS. 20 and 21, in one embodiment of the present invention the substrate 11 in the modulating section 150 of the device has a top portion 165 wherein extra dopants are introduced, for example by diffusion. This doped portion 165 may extend laterally from the modulating waveguides 131, 132 towards and under the associated electrodes 141-144. In one embodiment, the modulating waveguides 131, 132 and the doped substrate portion 165 are formed by Ti diffusion, although other suitable dopants may also be used in other embodiments. Generally, the dopants should be selected so as to increase the substrate conductivity in the doped portions if the conductivity within the waveguide 131 is greater than the conductivity of the rest of the substrate 11, and to decrease the substrate conductivity in the doped portions if the conductivity within the waveguide 131 is smaller than the conductivity of the rest of the substrate 11. FIG. 20 illustrates an embodiment wherein the doped portion 165 is shallow compared to the waveguide 131, while FIG. 21 illustrates an embodiment wherein the doped portion 165 extends deeper into the substrate 11 than the waveguide 131. The amount of extra Ti atoms in the doped region 165 is controlled, for example by controlling the thickness of a Ti layer deposited over the substrate 11 prior to the diffusion, so as not to cause the waveguide 131 to lose confinement of light therein, i.e. not to lose its waveguiding properties; generally a thinner doped portions, e.g. as in FIG. 20, may have a higher concentration of the doping material than the thicker doped portion as in FIG. 21. The addition of the optically non-guiding Ti-doped region 165 around the waveguides 131, 132 results in a flattening of the step and frequency responses of the DOPM by reducing the EO response of the device at low frequencies, i.e. less than about 0.1-1 Hz, which we attribute to an increase in the electrical resistivity of the doped portion 165 of the substrate 11 outside of the waveguides 131, 132, with the resulting effective resistance of the non-waveguiding portion of the substrate 11 being better matched to the effective resistance of the waveguiding portion of the substrate by the addition of the Ti atoms in regions of the substrate under and between the electrodes 141, 143 outside of the waveguide 131.

The Ti-doped region 165 can be fabricated in different ways. For example, in one embodiment a thin layer of Ti is evaporated over a wide area of the substrate 11 encompassing the modulating waveguides 131, 132 and substrate regions under the electrodes. A second layer of Ti is then evaporated in narrow regions defining stripes for the waveguides. Both Ti layers are then diffused together into the substrate in a single diffusion process, as known in the art for the formation of Ti waveguides. In this case, the depth of diffusion would be approximately the same for all Ti, as indicated by dashed line 166 in FIG. 21. In another embodiment, the steps of Ti deposition, patterning, and diffusion are repeated two times; the first set of steps creates the extra Ti region 165, while the 2^{nd} set of steps creates the Ti waveguide 131. The extra Ti “blanket” regions 165 can be formed along the entire length of the waveguides 131, 132 within the modulation region of the OPD, or only along a part of it. The latter design reduces the net effect of the extra Ti region, in case a full-size Ti ‘blanket’ 165 reduces the low frequency response more than desired. The flattening effect of the ‘blanket’ Ti doped region 165 upon the low-frequency EO response and the time-domain EO step response may be attributed to a reduction of a lateral non-uniformity of the electrical resistivity of the substrate regions in the electrode gap region between the signal and ground electrodes of the respective MWP.

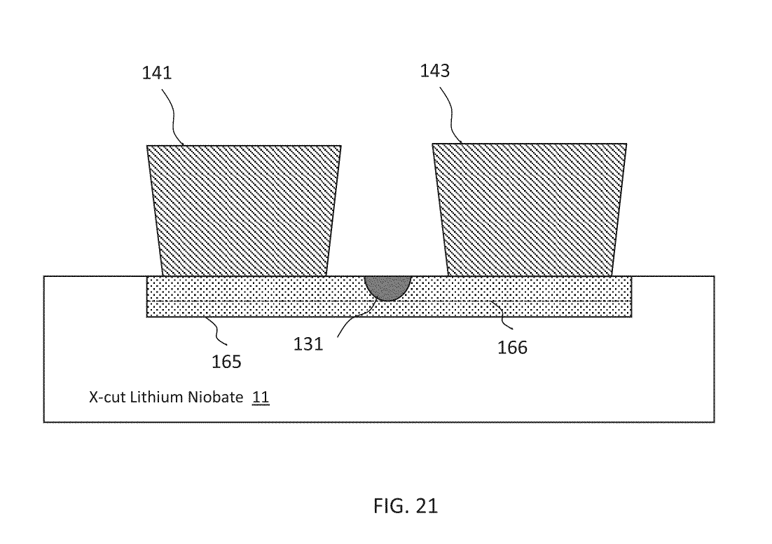

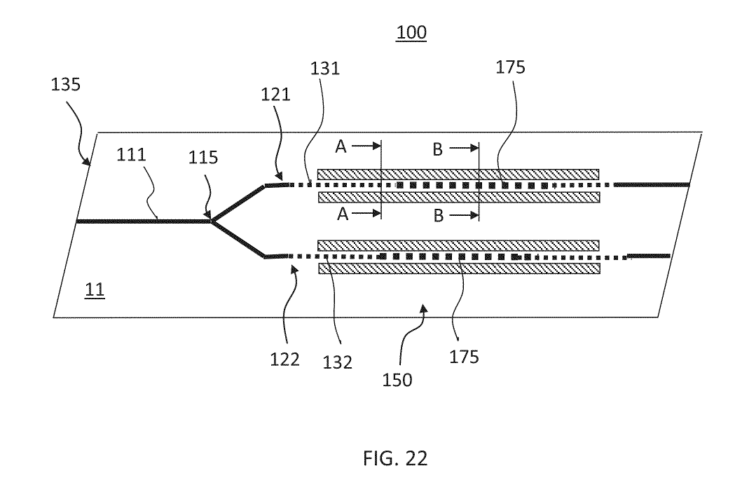

With reference to FIGS. 22 and 23, there is illustrated an embodiment of the DOPM 100 wherein the modulating waveguides 131, 132 are gradually widened towards middle portions thereof in the electrode region 150 in order to reduce the lateral non-uniformity of the substrate conductivity in a portion of the electrode gap region. In FIG. 22 the wider middle portions of the waveguides 131 and 132 are indicated at 175 with thick dotted lines. In FIG. 23, the dotted line labeled ‘175’ schematically indicates the cross-section of the waveguide 131 along the line ‘BB’ in the middle of the modulating waveguide 131 as shown in FIG. 22. A more uniform conductivity of the substrate 11 in the lateral direction, i.e. the general direction of current flow between the electrodes, helps to reduce the change in the EO frequency response in the sub Hz frequency range. The waveguide width is preferably gradually tapered up and down, preferably over a length of at least 50 μm for each taper, and more preferably over several hundred microns to several millimeters (mm). By way of example, the width of the waveguides 131, 132 may be increased in the middle portion by at least 20% and preferably by at least 50%. The 1/e width of the waveguide after diffusion, as defined by Ti concentration, is typically on the order of the electrode gap dimension. In the middle portion 175, the waveguide width after diffusion may be for example 50% larger than the electrode gap.

Referring back to FIGS. 8 and 9, there is illustrated an exemplary embodiment wherein the DOPM 100 has four electrodes 141-144 of equal width that may be for example in the range from 10 um to 100 um, with ˜30 um may be preferred for ease of manufacture in some cases. The electrode gap 146 may be, for example, from about 8 um to about 20 um, with 10 um to 12 um preferred. Referring to FIG. 9, analysis of the device behavior provides evidence that regions at the buffer/substrate interface may act as charge collection sites that are schematically indicated by thick dashed lines 177, causing screening charge to accumulate at the interface. The electric field from the screening charge partially or completely cancels the electric field created within the substrate 11 by applying a voltage to the electrodes 141, 143. The mobile charge is supplied by defects and/or impurities in the substrate 11 and/or waveguide 131, or is supplied by charge from the electrodes 141, 143 that leaks through the highly insulating buffer layer 155. After a sufficiently long time, the electrical field from the electrodes may be at least partially canceled out by field induced by the charge at the charge collection sites 177, which act as capacitor plates. This cancellation of field, when occurs, causes a reduction of the EO response at low frequencies. The corner frequency f_{cc}, where this cancellation begins to occur is a function of the leakage resistance R_{b} through the buffer layer 155, and the capacitance C_{cc} associated with the charge collection region 177, i.e. f_{cc}˜1/(C_{cc}R_{b}). The larger the resistance and capacitance, the lower is the corner frequency f_{cc}.

The waveguide boundary 178 may also act as a charge collection site. If the waveguide bulk conductivity is lower than the bulk conductivity of the substrate 11, charge may accumulate at the waveguide boundary 178, enhancing the electro-optic response at low frequencies. The corner frequency for that mechanism, f_{wg}, is primarily a function of the material conductivities and dielectric constant within and outside of the waveguide.

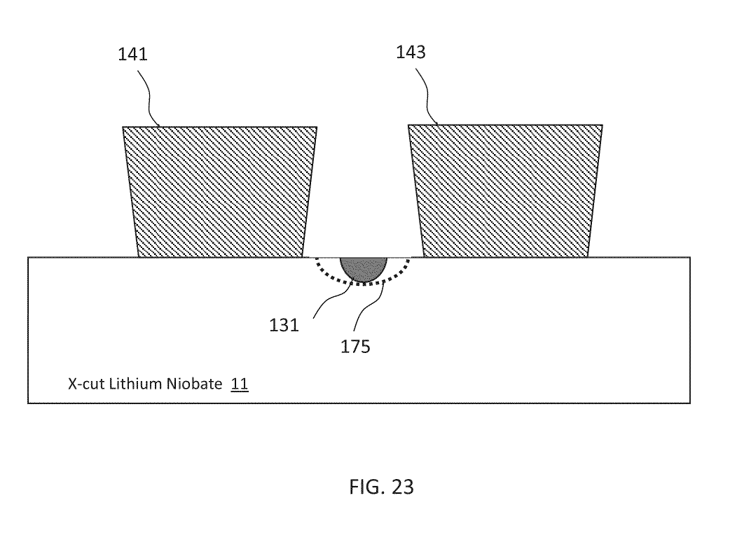

Referring now to FIG. 24, a schematic EO frequency response graph is shown that schematically illustrates a situation that can arise in some embodiments of DOPM 100, where the corner frequency f_{cc}, which is associated with the buffer/substrate interface charge collection sites 177, is too low, i.e. is less than the corner frequency f_{wg} where the smaller waveguide conductivity begins to introduce enhancement in the electro-optic response. If f_{cc} is too low, the introduction of the buffer layer 155 will not compensate for enhancement in the response due to the lower waveguide conductivity at frequencies between f_{cc} and f_{wg}. In FIG. 24, small-dashed line 201 schematically represents a contribution of an equivalent RC circuit representing only the charge dynamics associated with the buffer/substrate charge collection sites 177 into the electro-optic frequency response of the modulating waveguide. Line 202 with large dashes schematically represents the electro-optic response vs. frequency where only the effects associated with the conductivity difference between the waveguide and the surrounding substrate are considered. The solid line 203 schematically represents the resulting electro-optic response vs. frequency for the respective modulation section, which accounts for both these effects. Note that when f_{cc} is much smaller than f_{wg} the resulting EO response 203 has two corner frequencies and a large change in the EO response from one corner frequency to the next.

In accordance with an aspect of the present invention, this potential problem is addressed in the embodiments of FIGS. 12-19 by reducing the buffer area under the electrodes, which thereby reduces the area of the charge collection site 177.

In accordance with another aspect of the present invention, this potential problem is addressed by reducing the area, i.e. the footprint, of one of the electrodes, for example of the signal electrode, which also reduces the area of the charge collection site 177. The charge collection site 177 mirrors the geometry of the respective electrode in the presence of a full buffer layer 155, hence its area can be reduced by reducing the electrode footprint area.

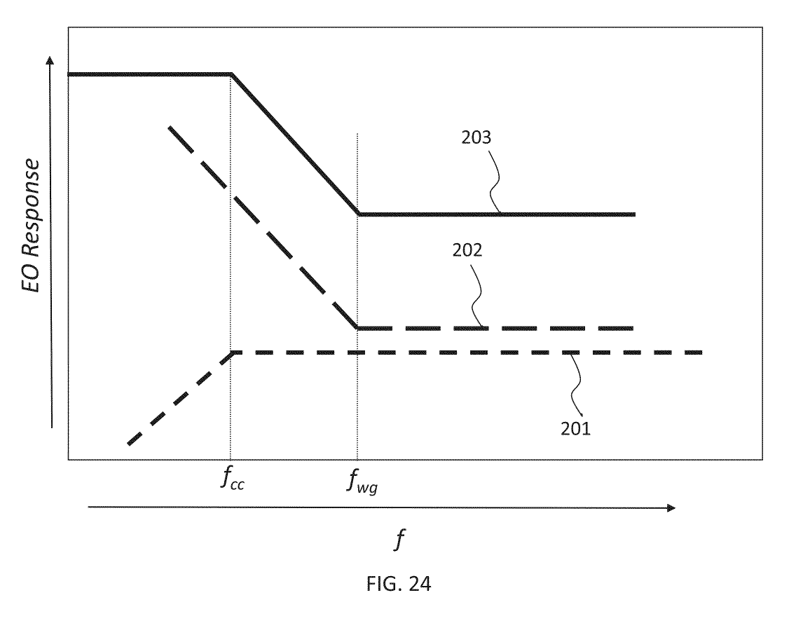

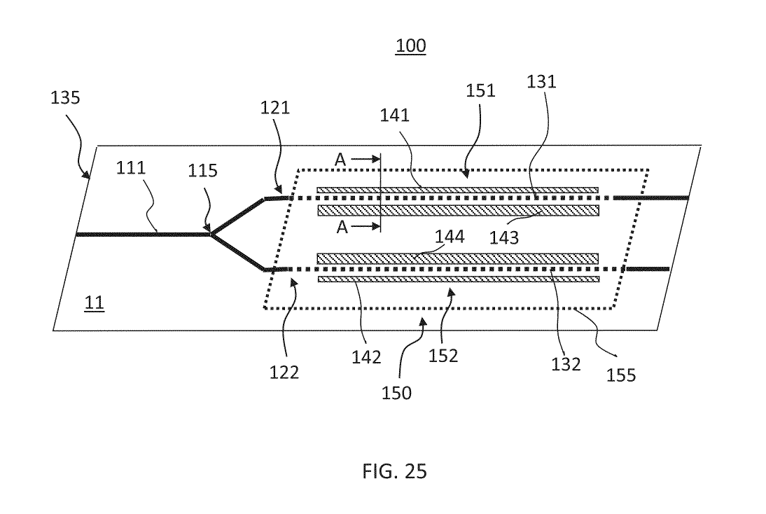

With reference to FIGS. 25 and 26, there is illustrated an embodiment of the DOPM 100 where the signal electrodes 141 and 142 has a smaller width than the ground electrodes 143, 144. As illustrated in FIG. 26 showing the cross-section of the first WPM 151 along the line AA, the area of the charge collections sites 177a under the signal electrode 141 is smaller than the area of the charge collections sites 177 under the ground electrode 143. The width of the ground electrodes 143, 144 can also be reduced, however, in the shown embodiment with four electrodes that may increase undesired electrical and electro-optic crosstalk between the first and second WPMs 151, 152. The increase in the cross-talk may be a disadvantage in applications wherein different modulating signals are applied to the two signal electrodes 141, 142, but may be tolerable for applications wherein both signal electrodes receive the same modulating signal.

By way of example, the width of the signal electrode 141 may be in the range of 4 μm to 15 um, with 10 um preferred, while the width of the ground electrode is in the range of 10 μm to 100 um or greater, with 30 um preferred in some embodiments. More particularly, the signal electrode 141 is at least 50% narrower than the ground electrode 143, and preferably 2 to 4 times narrower than the ground electrode 143. The electrode gap 146 may range from 10 μm to 20 μm for LN based devices, with 14 um preferred in one embodiment. The electrode thickness can be any value that is suitable for manufacturing and provide low electrical resistance of the electrode, from 1000's of Angstroms, to 10 μm or more. A thickness of 4 μm to 6 μm may be preferred if the electrodes are fabricated with an electroplating process. A thickness of 1000 to 5000 A may be preferred if the electrodes are deposited by sputter deposition.

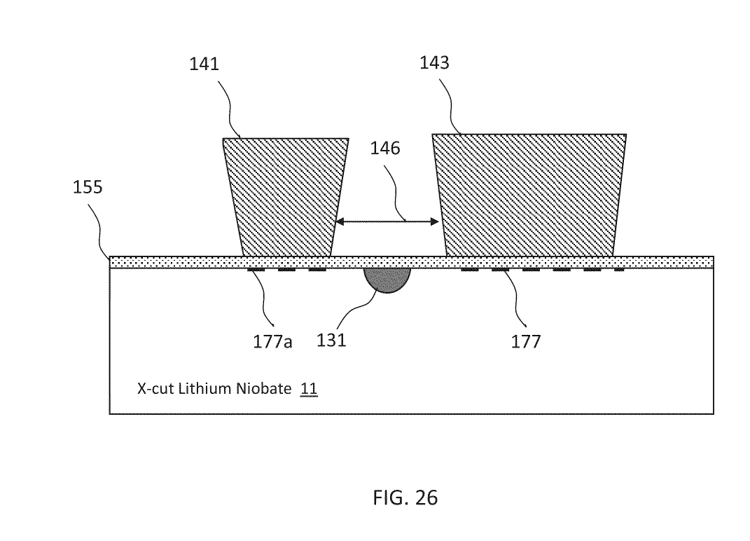

Referring now to FIG. 27, there is shown a schematic EO response graph for the device of FIGS. 25, 26, illustrating the effect of the reduced width of the signal electrode 141 on the device EO frequency response at low frequencies. The contribution into the frequency response originating from the charge dynamics at the buffer/substrate interfaces 177, 177a is now represented by line 210′. Line 202, which remains unchanged from FIG. 24, represents the contribution of the charge dynamics at the waveguide 131. The resulting total EO response of the DOPM of FIGS. 25, 26 with the narrow signal electrode is represented by solid line 203′. The reduction of charge collection site area 177a at the signal electrode 141 reduces the capacitance associated with that region, thereby increasing the corner frequency f_{cc} to be close to f_{wg}. The result is a decrease in the variation of the EO response 203′ of the device vs. frequency, as compared to the EO response 203 illustrated in FIG. 24.

The slopes of EO responses 202, 201′ vs. frequency at f<f_{cc}, f_{wg} are of opposite sign but are optimistically shown to have a same magnitude. Although in real-life device these slopes may not match perfectly in magnitude, we found that the slopes are sufficiently close to produce useful devices. Still further optimization of the device structure is possible by adjusting dimensions and geometry of the electrode system and the buffer layer. The slope of the response curve 201′ associated with the charge collection sites 177, 177a can be reduced by using the buffer layer under only a portion of the electrode 141 and/or 143, as described hereinabove with reference to FIGS. 12-19. For such embodiments, the ‘buffer’ EO response 201′ represents a weighted sum of respective curves for electrode portions with and without buffer, the ‘with buffer’ response being represented by the response curve 201′, and the ‘without buffer’ response being a straight horizontal line. The slope of the response curve 201′, associated with the charge collection sites 177, 177a can be increased by increasing the buffer thickness, however, that change may also reduce the corner frequency f_{cc} as the net series resistance associated with the buffer increases. Conversely, a thinner buffer will reduce the slope, but is expected to increase f_{cc}.

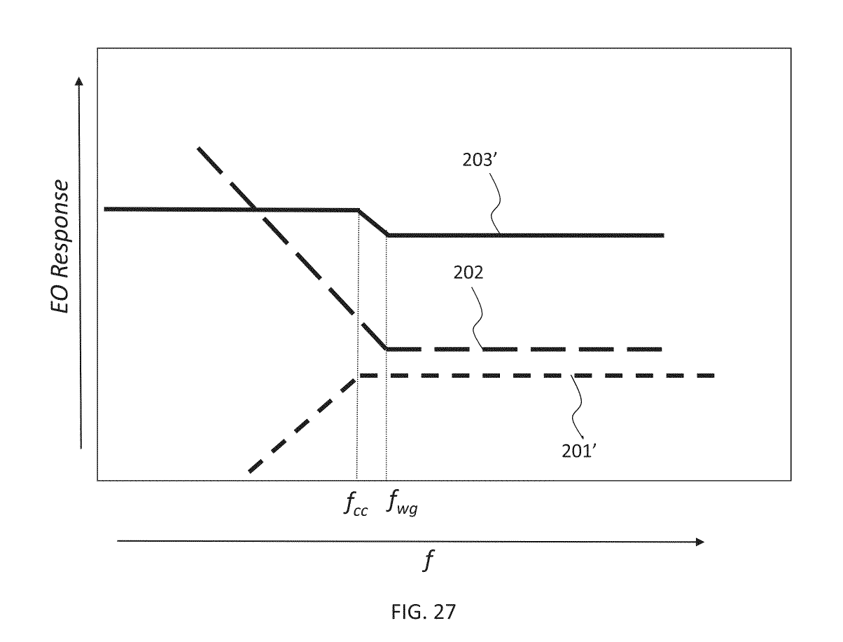

With reference to FIG. 28, in another embodiment of the DOPM 100 a second ground electrode 143a, 144a is added on the opposite side of each of the signal electrodes 141, 142, resulting in a ground-signal-ground electrode configuration for each of the phase modulation sections 151, 152 of the device. Accordingly, this embodiment of the DOPM 100 includes 4 ground electrodes that are disposed over the substrate 11 so that each of the signal electrodes 141, 142 has a ground electrode extending alongside at each side thereof. The electrode system shown in FIG. 28 forms two electrode gaps of width between 5 and 30 μm in each of the phase modulation sections 151, 152, with a respective modulating waveguide 131 or 132 positioned in one of the two electrode gaps. Advantageously, we found that the presence of the additional ground electrode extending along the signal electrode on opposite side from the associated waveguide reduces electrical and/or electro-optic crosstalk between the two phase modulation sections 151, 152 of the device. Note that there is an additional charge collection site under each added ground electrode in the presence of the buffer layer 155, however such a design still has a suitably low electrode capacitance if the width of the signal electrodes is small enough, for example close to 10 μm. We found that at least in some embodiments the addition of the extra ground electrodes appear to reduce the effects of slow charge migration in the substrate 11 taking longer than 1 sec, thereby having an advantageous flattening effect upon the step EO response and the EO frequency response of the device at below 1 Hz.

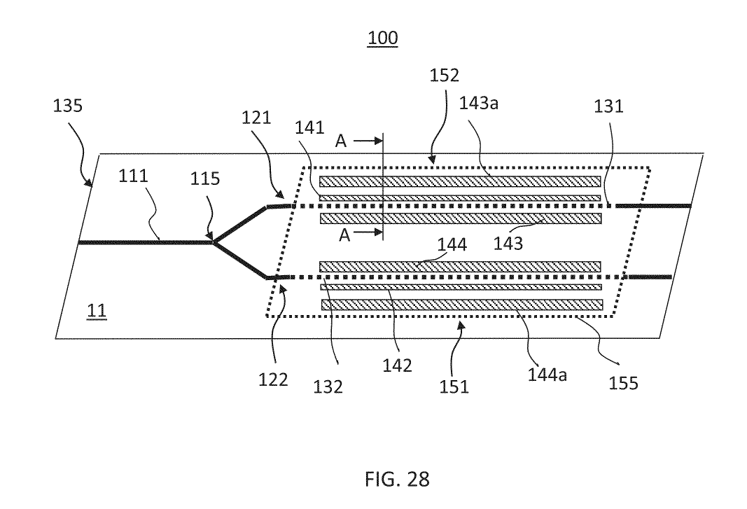

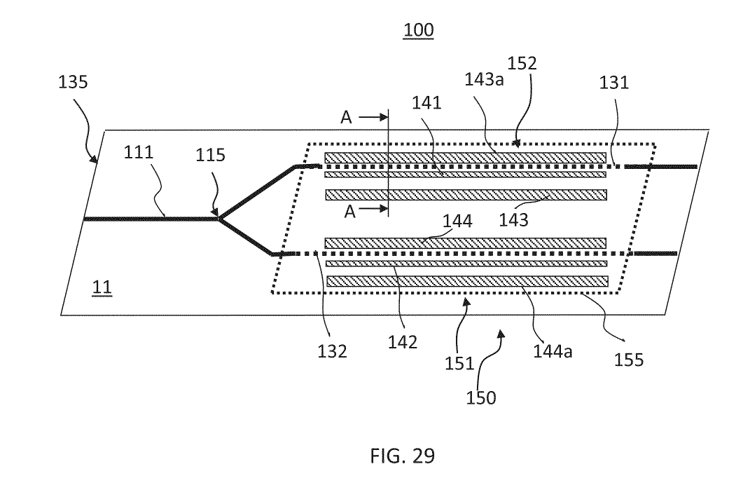

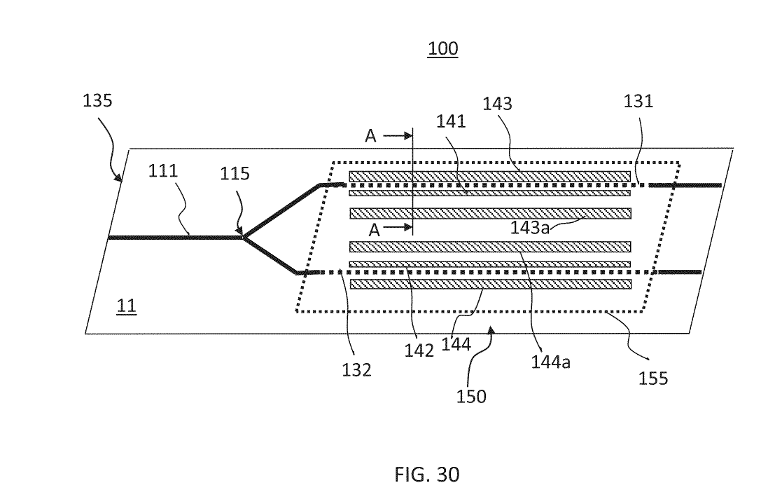

FIGS. 29 and 30 illustrate embodiments with two other possible electrode configurations having the additional ground electrodes 143a, 144a, with the waveguides 131, 132 are on different sides of their corresponding signal electrode. There are three such electrode combinations: (1) only two ground electrodes between the two waveguides 131, 132, or (2) one signal and two ground electrodes between the two waveguides 131, 132, or (3) two signal and two ground electrodes between the two modulating waveguides 131, 132. FIG. 31 illustrates an embodiment wherein the two innermost ground electrodes 143a, 144a in the configuration of FIG. 30 are merged in one single ground electrode, thereby providing a three ground electrode design with a further improved shielding and reduced electrical and electro-optic crosstalk.

We note that at least some of the advantages provided by the additional ground electrodes remain also in the absence of the buffer layer 155. Accordingly, embodiments of the DOPM 100 with the electrode configuration as illustrated in FIGS. 28-31, but without the buffer layer 155 are within the scope of the present invention.

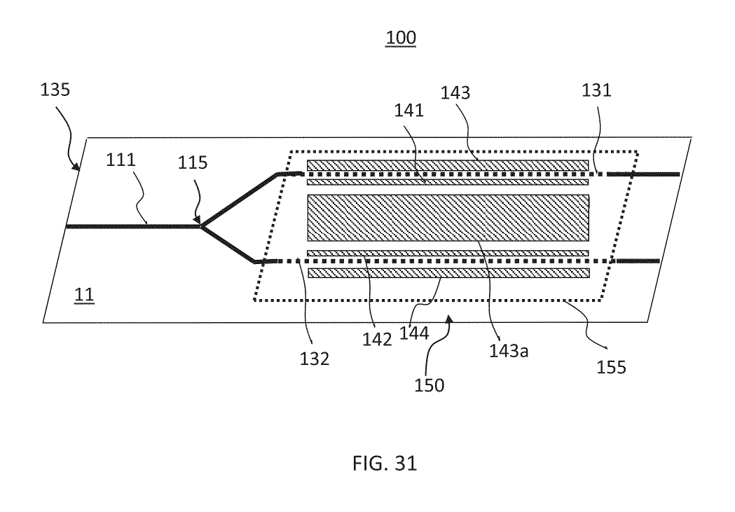

With reference to FIG. 32, there is illustrated an embodiment of the DOPM 100 similar to that of FIG. 28, but wherein the modulating Ti waveguides 131, 132 and the electrodes extend into bends 181, 182 of the respective modulating waveguides 131, 132 immediately following the Y-branch 115. The innermost ground electrodes 144 and 143 may be merged into a single ground electrode similarly to FIG. 31, for the reasons of improved shielding and reduced electrical and electro-optic crosstalk.

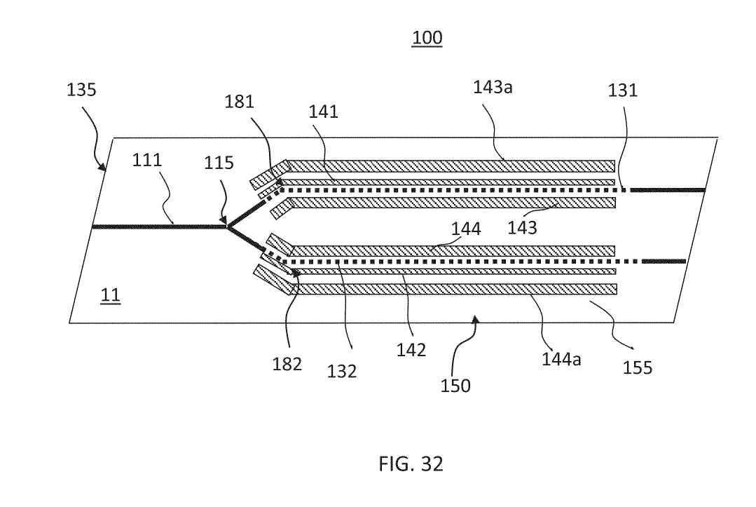

Turning now to FIG. 33, there is schematically illustrated a rotation sensor in the form of a fiber-optic gyroscope (FOG) 900 that incorporates the DOPM 100 in accordance with an embodiment of the present invention. An optical source 1, typically a laser, light emitting diode (LED), or other suitable light source, provides light that travels through a fiber-optic coupler 2 and through the DOPM 100 to a fiber coil 6, entering the fiber coil 6 simultaneously at both ends 5 thereof. The FOG 900 senses rotation via the Sagnac effect as described, for example, in K. Kissa and J. E. Lewis, “Fiber-optic gyroscopes,” Chapter 23 from “Broadband Optical Modulators,” edited by Antao Chen and Ed Murphy, CRC Press, Boca Raton Fla., 2012, pp. 505-515, which is incorporated herein by reference. Rotation of the fiber coil 6 causes a non-reciprocal phase shift between the counterclockwise and counterclockwise propagating optical beams in the fiber coil 6. This non-reciprocal phase shift in the fiber coil 6, together with the phase modulation in the DOPM 100, creates a change in light intensity at the photodiode 3 due to coherent interference of the two beams as they merge in the Y-junction 115 of the DOPM 100 after transit in the fiber coil 6. The effect of phase modulation is non-reciprocal, as well, due to the transit time through the fiber coil, hence it can be used to interact with the non-reciprocal phase shift produced by rotation. The photodiode 3 produces an electrical signal proportional to the intensity of the received light, and variations in that signal provide an indication of the angular rotation speed of the fiber coil 6. The fiber-optic coupler 2 can be an evanescent directional coupler or an optical circulator. The DOPM 100 in FIG. 33 is schematically illustrated as having a buffer layer 155 that extends throughout the dual modulation region 150 of the device insulating the electrodes from the substrate; in other embodiments of the FOG 900 the DOPM 100 may include any one or more of the features of the present invention that have been described hereinabove with reference to FIGS. 8-32, including only partially buffered electrodes, one or more additional ground electrodes, and/or doped layers under the electrodes.

The aforedscribed embodiments of the invention are by way of example only, and many variations of the exemplary designs shown in FIGS. 8 to 32 are possible.

For example, each of the aforedescribed embodiments of DOPM 100 may include features of one or more of the other embodiments of DOPM 100 as described hereinabove. For example, the electrode systems with the dual ground electrodes per modulating waveguide as illustrated in FIGS. 28-32 may be disposed fully or partially over the buffer layer 155, and/or over the ‘blanket’ doped regions 165, or directly upon the undoped substrate 11. Similarly, the asymmetrical electrode systems of FIGS. 25, 26 may be disposed fully or partially over the buffer layer 155, and/or over the ‘blanket’ doped regions 165, or directly upon the undoped substrate 11.

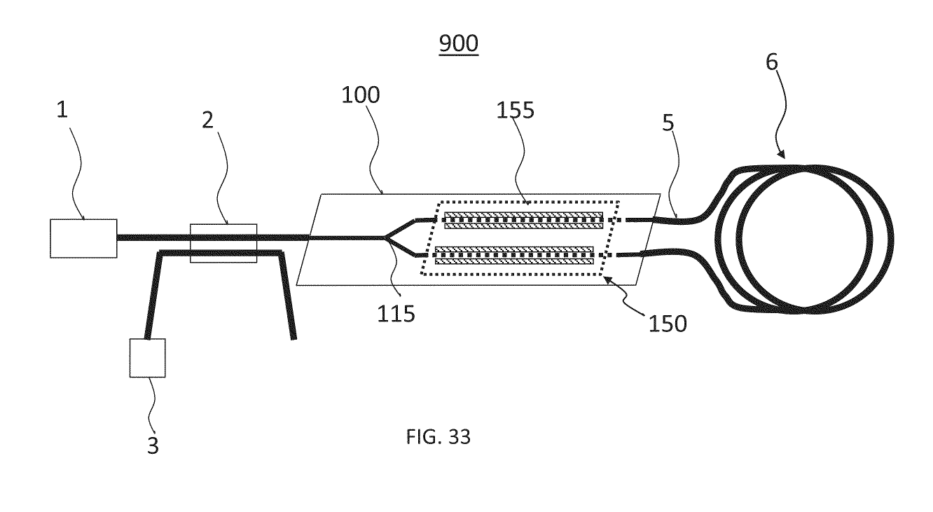

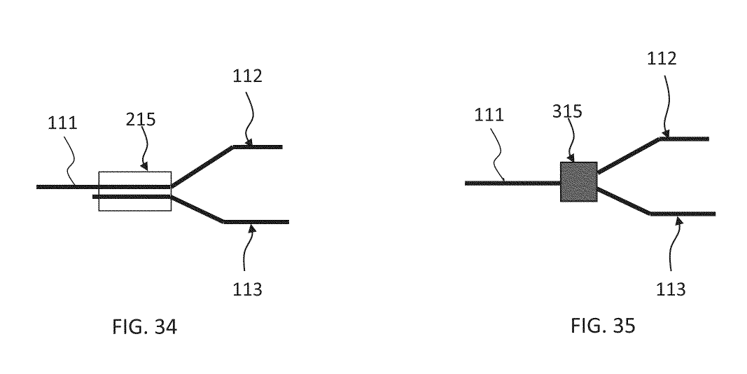

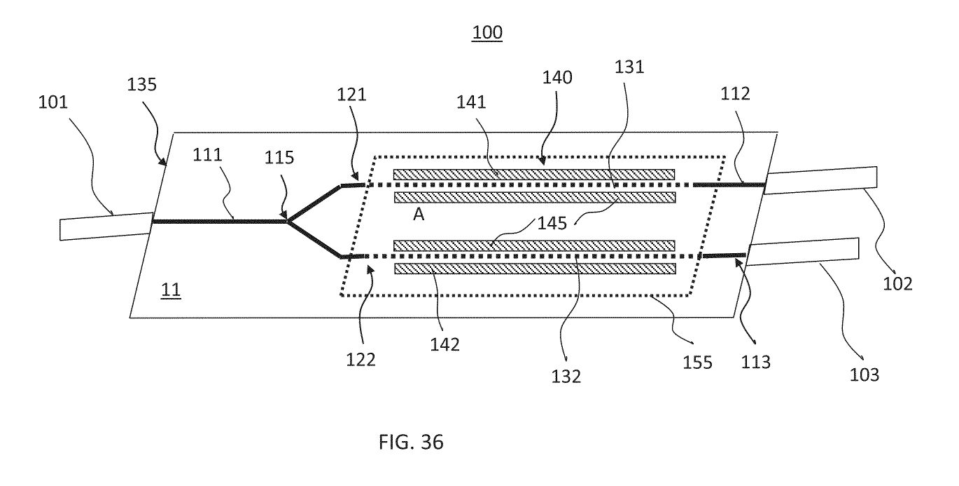

Although the optical splitter-combiner 115 has been shown hereinabove to be in the form of a waveguide Y-junction or Y-branch, it may also be in the form of a directional waveguide coupler as illustrated in FIG. 34 at 215, or incorporate a multi-mode interference coupler (MMI) as illustrated in FIG. 35 at 315, or any other suitable structure having the desired light splitting and combining functionality. The front and back facets 135 of the DOPM 100 may be angled at an angle of a few, for example 6, degrees with respect to the input and output waveguides 111, 112 and 113 as known in the art, but may also be orthogonal to the waveguides. The optical ports 101, 102 and 103 may be in the form of waveguide terminations at the facets 135, or may be in the form of fiber-optic pigtails, i.e. length of single mode or multi-mode optical fiber coupled to said waveguide terminations at the facets 135, as schematically illustrated in FIG. 36, or may be in any other form suitable as conduits for light to enter and exit the input-output waveguides 111-113, for example free-space optical assemblies that focus the light from fiber to waveguide and vice-versa, or lensed fibers that do not directly contact the substrate.

Furthermore, although the buffer layer 155 has been considered as an external element to the substrate 11, in accordance with one aspect of the present invention the buffer layer is considered to be a part of the substrate, in which case the buffer layer is referred to as a top buffer portion of the substrate. In this aspect of the invention, the top buffer portion of the substrate may also be in the form of the doped substrate portion 165, such as described hereinabove with reference to FIGS. 20, 21. According to this aspect of the invention, the top buffer portion of the substrate should have a bulk electrical resistivity that is at least 20% greater than the bulk electrical resistivity of the rest of the substrate.

Of course numerous other embodiments may be envisioned without departing from the spirit and scope of the invention.

We claim:

1. A Y-branch dual optical phase modulator for use in low-frequency applications, comprising:
a substrate comprising electro-optical material;
first, second and third optical ports for coupling light in and out of the substrate;
a Y-branch waveguide structure supported by the substrate for optically coupling the first optical port to each of the second and third optical ports and comprising:
a first waveguide arm optically connected to the first optical port for receiving light therefrom;
a second waveguide arm terminating at the second optical port and comprising a first waveguide phase modulator (WPM) comprising a first modulating waveguide formed in the substrate;
a third waveguide arm terminating at the third optical port and comprising a second WPM comprising a second modulating waveguide formed in the substrate; and,
an optical splitter formed in the substrate and optically connecting the first waveguide arm to each of the second and third waveguide arms for directing the light from the first input port to each of the second and third optical ports;
wherein the first and second WPMs further include an electrode system comprising a first signal electrode disposed upon the substrate alongside the first modulating waveguide in the first WPM, a second signal electrode disposed upon the substrate alongside the second modulating waveguide in the second WPM, and at least one ground electrode disposed upon the substrate so as to define first and second electrode gaps extending over and along the first and second modulating waveguide segments, respectively, for supporting a lateral electrical field in any one of the first and second modulating waveguides when a voltage is applied to a respective one of the first or second signal electrodes; and,
a buffer layer disposed upon the substrate underneath at least a first portion of the electrode system for reducing a low-frequency modulation efficiency of at least one of the first and second waveguide phase modulators for flattening a frequency response thereof at modulation frequencies below 1 Hz.

2. The modulator of claim 1, wherein the buffer layer is absent under a second portion of the electrode system.

3. The modulator of claim 2, wherein the second portion of the electrode system extends along at least one of the signal and ground electrodes.

4. The modulator of claim 2, wherein the second portion of the electrode system extends across at least one of the ground and signal electrodes.

5. The modulator of claim 1, wherein the at least one ground electrode comprises three or more co-planar stripe electrodes that are disposed over the substrate so that each of the first and second signal electrodes has a ground electrode extending along each side thereof.

6. The modulator of claim 5, wherein each of the first and second signal electrodes is disposed between two of the three or more ground electrodes at a distance therefrom from 5 to 30 μm.

7. The modulator of claim 1, wherein the at least one ground electrode comprises first and second ground electrodes having a ground electrode width and disposed to form first and second electrode gaps with the first and second signal electrodes, respectively, and wherein the first and second signal electrodes each has a signal electrode width that is smaller than the ground electrode width.

8. The modulator of claim 7, wherein the signal electrode width is in the range of 4 to 15 um, or is at least 30% smaller than the ground electrode width.

9. The modulator of claim 1 wherein the substrate comprises x-cut lithium niobate (LN).

10. The modulator of claim 9, wherein at least a portion of each of the first and second modulating waveguides is doped with Titanium (Ti) and has a Ti concentration and a Ti doping depth that are sufficient for guiding light therein.

11. The modulator of claim 10, wherein the substrate comprises a top doped portion located directly under at least one of the signal and ground electrodes extending towards at least one of the first and second modulating waveguides, and wherein the top doped portion has a greater electrical resistivity than the rest of the substrate.

12. The modulator of claim 11, wherein the top doped portion is doped with Titanium and has a Ti concentration and a Ti doping depth that is insufficient for guiding light therein for reducing a lateral non-uniformity of electrical resistivity of the substrate across the electrode gaps.

13. The modulator of claim 1, wherein each of the modulating waveguide segments gradually widens towards a middle portion thereof over a length of at least 50 μm for reducing a lateral non-uniformity of electrical resistivity of the substrate across the electrode gaps.

14. The modulator of claim 1, wherein each of the modulating waveguide segments has a width that is at least 20% greater at the middle portion thereof than at at least one end thereof.

15. The modulator of claim 1, wherein the optical splitter comprises one of a waveguide directional coupler, a waveguide Y-junction, or a multimode interference coupler (MMI).

16. The modulator of claim 1, wherein the buffer layer comprises an electrically insulating material having a volume resistivity that is at least two times greater than a volume resistivity of the substrate.

17. The modulator of claim 16, wherein the buffer layer comprises benzocyclobutene (BCB).

18. A Y-branch dual optical phase modulator, comprising:
a substrate comprising electro-optical material;
first, second and third optical ports for coupling light in and out of the substrate;
a Y-branch waveguide structure (YBWS) formed in the substrate for optically connecting the first optical port with each of the second and third optical ports, comprising:
a first waveguide coupled to the first port,
a second waveguide coupled to the second port and comprising a modulating waveguide segment,
a third waveguide coupled to the third port and comprising a modulating waveguide segment, and
an optical splitter optically connecting the first waveguide to each of the third and second waveguides;
an electrode system comprising two signal electrodes and at least one ground electrode that are all disposed upon a same face of the substrate alongside the modulating waveguide segments of the second and third waveguides and forming first and second electrode gaps separating the signal electrodes from the at least one ground electrode, so that the first modulating waveguide segment is located in the first electrode gap and the second modulating waveguide segment is located in the second electrode gap for inducing an electric field in the respective first and second modulating waveguide segments when a voltage is applied between the respective signal and ground electrodes, the electrode system defining first and second phase modulation sections comprising the first and second modulating waveguide segments, respectively; and,
wherein the substrate comprises a top buffer portion upon which at least a portion of the electrode system is disposed, the top buffer portion having a bulk electrical resistivity that is greater than a bulk electrical resistivity of the rest of the substrate for reducing low-frequency contributions of at least one of the waveguide modulating segments in an electrical resistance between each of the signal electrodes and the at least one ground electrodes for flattening a frequency response of the respective waveguide phase modulation section at modulation frequencies below 1 Hz.

19. A dual optical phase modulator of claim 18, wherein the top buffer portion of the substrate comprises one of a doped portion of the substrate or a buffer layer deposited upon the rest of the substrate.
